(19) United States
(12) Patent Application Publication
(10) Pub. No.: US 2022/0016691 A1
(43) Pub. Date: Jan. 20, 2022

(54) METALLIC DISPENSING LIDS FOR CUPS AND METHOD OF MAKING THE SAME

(71) Applicant: Ball Corporation, Westminster, CO (US)

(72) Inventor: Anthony J. Scott, Westminster, CO (US)

(21) Appl. No.: 17/376,010

(22) Filed: Jul. 14, 2021

Related U.S. Application Data
(60) Provisional application No. 63/051,381, filed on Jul. 14, 2020.

(51) Int. Cl. B21D 51/44; B65D 6/30; B65D 43/02; B65D 47/06

(52) U.S. Cl. CPC B21D 51/44; B65D 7/36; B65D 43/0212; B65D 2543/00277; B65D 2543/00046; B65D 2543/00092; B65D 47/06

(57) ABSTRACT

Embodiments of the present disclosure relate to novel systems, devices, and methods for providing metallic dispensing lids for cups. The novel lids provided herein snap onto containers, including single-use cups, and permit drinking liquids while minimizing spillage of the liquids in the cups. The metallic dispensing lids are easily recyclable and prevent spillage from single-serve cups.

### CROSS-REFERENCE

This application claims priority under 35 U.S.C. § 119(e) to U.S. Provisional Patent Application Ser. No. 63/051,381 filed on Jul. 14, 2020 and entitled “Metallic Dispensing Lids for Cups and Method of Making the Same,” which is incorporated by reference herein in its entirety.

### FIELD OF THE INVENTION

Embodiments of the present invention generally relate to lids for cups or containers, and more specifically to metallic dispensing lids for cups and methods of making the same.

### BACKGROUND OF THE INVENTION

Current dispensing lids, for both single-use cups and reusable cups, are typically made of plastic or paper. Note that the terms “cup” and “container” are used interchangeably herein. Although plastic containers and lids are convenient for consumers and are inexpensive to manufacture, plastic components are difficult to recycle and typically end up in landfills. Paper lids and containers require coatings and/or plastic linings if the lid or container will contact moisture or other liquids. These coatings and linings make recycling the paper lids and containers difficult, which means many of the paper lids and containers also end up in landfills. Compostable lids and containers are not only expensive to manufacture, but also require specialized composing facilities to truly compost these items, especially if the lid or container is for use with liquids since special coatings and linings must be used to prevent the cup or lid from disintegrating.

Due to the numerous limitations associated with the prior art described above, the following disclosure describes metallic dispensing lids for cups.

### SUMMARY OF THE INVENTION

Currently there are no metallic lid offerings for single-use beverage cups. Accordingly, there exists a significant need for lids for cups, specifically single-use or multi-use cups, that are truly recyclable, function with liquids, and are inexpensive to manufacture. Moreover, there has been a long-felt and unmet need to provide a removable metal lid that is reusable and recyclable. There has also been a need to provide a lid that is stackable to enhance shipping and storing of a plurality of lids.

These and other needs are addressed by the various embodiments and configurations of the present invention. Embodiments of the invention relate to novel systems, devices, and methods for providing metallic dispensing lids for cups. The novel lids provided herein snap onto containers, including single-use cups, and permit drinking liquids while minimizing spillage of the liquids in the cups.

In some embodiments, the metallic lids are designed to function with and complement metal tapered cups. However, in various embodiments, the metallic lids can be used with any single-use or reusable cups including plastic cups and paper cups.

Although embodiments of the invention generally relate to metallic lids, the invention and features described herein could easily be implemented on plastic, paper, ceramic, or silicone lids.

In various embodiments, metallic lids are provided comprising thin-walled aluminum or aluminum alloy. Alternatively, the lids can comprise a metal other than aluminum, including tin, magnesium, copper, steel, titanium, iron, chromium, manganese, silicon, zinc, or other recyclable metal or metal alloy, including metals and alloys made from recycled material. Aluminum is the most recycled material available and is infinitely recyclable. Preferably, the metallic lids are provided comprising a recycled aluminum alloy, for example any of the aluminum alloys identified in U.S. Pat. No. 9,517,498, which is incorporated herein by this reference. Various embodiments, including those comprising thin-walled aluminum provide lids that are lightweight, are formed of a recycled and/or recyclable material, and are more rigid, useful, and durable than conventional plastic or paper lids, for example. In various embodiments, the lids are all metal and fully recyclable.

In some embodiments, the lids are designed for dispensing liquids from beverage cups. The lid can be a selectively removable snap-on lid, meaning the lid snaps onto the curled edge of a container, for example a beverage cup, for retention purposes. In some embodiments, the lid is friction fit to the inner diameter of the cup so as to not require a snapping feature. Thus, an outer wall of the lid securely fits against the inner diameter of the top end of the cup.

In some embodiments, the lid has a larger outer diameter than the outer diameter of the top of the cup, i.e., the cup's curl. The lid's larger outer diameter allows users to better remove the lid from the cup.

In various embodiments, the lid includes a dispensing orifice (also called a pour opening or dispensing hole) and a vent hole for ease of pouring liquid out of the dispensing orifice. The vent holes and dispensing orifices shown in the drawings attached hereto can be larger, smaller, or other shapes in other embodiments and be within the scope of the present invention. For example, the vent holes can be cut into the shape of a logo or letter depending on the customer's desires. The dispensing orifices should be large enough for a consumer to drink through without using a straw. In some embodiments, the dispensing orifice has a triangular shape with the wide part proximate the perimeter of the center panel and the skinny part positioned closer to the center of the lid such that the liquid passes through the wide part as the consumer drinks the beverage and air passes through the skinny part of the dispensing orifice. The shape of the dispensing orifice is also aesthetically pleasing in some embodiments. In various embodiments, the dispensing orifice is what is called a “sipping lid” in the industry.

In some embodiments, the dispensing orifice and/or the vent hole are not fully cut into the lid and/or are not actually open when the consumer puts the lid on the cup. Rather, the dispensing orifice and/or the vent hole each include a score line defining the opening that does not go all the way through the metal such that there are no holes or openings in the lid when the consumer receives the lid. In some embodiments, the score line defining the dispensing orifice and/or the vent hole goes all the way through the lid and may or may not be resealed with a coating material, i.e., post repair to close the opening. The purpose of this, rather than a score residual where the score does not go all the way through the lid, is ease of opening since the lid. Because the lid does not need to retain pressure, post-repair can be used rather than a score residual. A score residual requires a significant force that is not possible for many people and is uncomfortable for most people to open. With either option, the consumer can use his/her thumb, a key, or another device to push on the tear panel (i.e., material) within the score line, fracture the score, and break the material along the score line to open the opening, similar to a traditional pull tab lid with a tear panel and score line that is later opened by the consumer with the pull tab. Advantages of this embodiment include that the consumer can walk to his/her desired location with no openings in the lid, which keeps the beverage colder or warmer (as desired) and prevents spilling. Then the consumer can open the dispensing orifice and/or the vent hole when he/she reaches his/her desired location.

The shape of the dispensing orifice and/or the vent hole may be chosen based on the desired flow rate and the ease of fracturing an associated score. For example, one embodiment of the present disclosure contemplates providing dispensing orifice and/or vent hole score with a triangular shape, the triangular shape having a stress concentration at the apex of the triangle, thus reducing the amount of force necessary to fracture the score near the apex. Additionally, the triangular shape allows an opening tool to focalize the opening force on a smaller area near the apex as opposed to a round score shape.

In some embodiments, a stiffening structure is provided on the dispensing orifice and/or the vent hole that adds stiffness to the panel area (i.e., within the score) near the score or an optional secondary score. Because the lid is not connected to a pressurized container, a secondary score may not be needed. The stiffening structure may have various shapes and configurations. For example, the stiffening structure may be a raised or recessed portion of the central panel, such as a bead. Alternatively, the stiffening structure can be a separate element that is coupled to the central panel. By adding stiffness to the central panel near a primary or optional secondary score, the stiffening structure will reduce panel deflection and thus any downward force exerted on the panel portion within the score will be focused on the score or on the secondary score, if there is a secondary score. Thus, the opening force required to fracture the score or secondary score of the dispensing orifice panel and/or the vent panel is reduced.

Further, in some embodiments, a form feature is provided that increases the stiffness of the panel near the score or the secondary score and provides a seat for an opening tool. In these embodiments, the form feature may have various shapes and configurations. For example, the form feature may be a raised or recessed portion of the panel, such as a ramp. Alternatively, the form feature can be a separate element that is coupled to the central panel. By adding stiffness to the central panel near the score or the secondary score, the form feature reduces the opening force required to fracture the score or the secondary score. By providing a seat for an opening tool, the form feature reduces slippage and increases force transfer from an opening tool to a gate associated with an opening. Moreover, in some embodiments, a safety fold provides additional stiffness around the opening.

In still further embodiments, the lids may be manufactured and sold without any holes or openings. Thus, the lid would act solely as a cover. Alternatively, the purchasing company (i.e., a store, coffee shop, or restaurant) could punch its desired holes into the lids, which gives each purchasing entity the ability to customize the lids to its desired purpose and use. In some embodiments, the lid comprises a raised feature to aid in residual liquid draining back into the dispensing orifice. Additionally, various embodiments of the lid include drink enhancing features that provide the consumer with a better lip feel. In still further embodiments, the lid includes a dip or recessed portion to accommodate a user's nose. In additional or alternative embodiments, the center panel can be decorated with customer specific artwork and/or logos.

In various embodiments, the metal is coated to prevent discoloration or deterioration from extreme pH products. The coatings used for the lids can be the same coatings used on container end closures (e.g., double-seamed end closures with stay on tabs), for example epoxy coatings or BPANI coatings. Alternatively, the lid could be uncoated but chemically treated to resist discoloration. For example, the lid could have a chemical treatment such as zirconium or anodizing.

In preferred embodiments, a metallic lid is provided with a constant wall thickness along at least a portion of the lid. For example, the entire lid can have a uniform thickness of between about 0.004 inches and about 0.010 inches. In preferred embodiments, the lid has a uniform thickness of between about 0.0045 inches and about 0.008 inches. In more preferred embodiments, the lid has a uniform thickness of between about 0.005 inches and about 0.007 inches. In a most preferred embodiment, the lid has a uniform thickness of about 0.006 inches.

In various embodiments, the lid is securely interconnected to the cup via friction fit sidewalls, i.e., the interaction between the lid sidewall and the cup sidewall or using lug features or other dimple features. The lug features can be formed in the lid curl and snap outward to receive the cup's curl and then snap back into place around the cup's curl. The dimple features would function similarly and be positioned on a portion of the lid positioned below the cup curl when the cup and lid are interconnected. The dimple feature may be embossed, pressed, or formed in the lid.

In some embodiments of the method of making the lids, the process begins with a precoated coil that is fed into a stamping press to form a blank of any various shapes and sizes. The blank is subsequently formed into an intermediate aluminum form called a cup. The cup is fed into a transfer press, which performs the following steps to the cup to form a lid: secondary draw, curl, lug formation, and vent and dispensing hole pierce. Then the lids exit the transfer press and are stacked, bagged, and palletized.

In various embodiments of the method of manufacturing the lids, the process begins with a precoated coil that is fed into a stamping press. Then a series of holes are punched into the metal; the series of holes will become the dispensing hole and the vent hole in the final product. Next, the metal is cut into a circle called a blank. The blank is then drawn into a near-finished version of the final lid product with a small flange around the circumference. The flange is then curled over to hide the cut edge from the consumer. The curl also adds rigidity and creates a surface to pull against when removing the lid from a cup.

In some embodiments, the method of making the lids can occur in a single forming machine, and in other embodiments the method of making the lids can occur in a series of forming machines. Moreover, a plurality of lids can be made in each action of a machine. In another embodiment of the present invention, a lid is provided that is manufactured with conventional manufacturing equipment.

In some embodiments, a metallic dispensing lid is provided comprising: a center panel having a dispensing orifice; a sidewall interconnected to a perimeter of the center panel, the sidewall extending upwardly from the center panel; a raised rim interconnected to the sidewall; and a curl interconnected to an outer portion of the raised rim and positioned below the raised rim.

In various embodiments, the lid further comprises at least two lug features in the curl, wherein the at least two lug features are biased inwardly and configured to removably interconnect the lid to a peripheral curl of a cup. In some embodiments, the dispensing orifice has a triangular shape with a wide end and narrow end, and wherein the wide end is positioned proximate to the perimeter of the center panel. In some embodiments, the dispensing orifice is initially closed by a tear panel defined by a score line, wherein the score line extends at least partially through a thickness of the lid, wherein at least a portion of the tear panel stays attached to the center panel after opening. In some embodiments, the at least two lug features are positioned at opposite ends of the metallic dispensing lid and can be moved between a first position where the at least two lug features are retained to the cup and a second position where the at least two lug features are released from the cup to allow removal of the lid, and/or the at least two lug features each comprise an inner curved portion that is oriented toward the cup and shrouds the end of the curl from contact with a user removing the metallic dispensing lid. In various embodiments, the at least two lug features extend a predetermined distance around the curl, and wherein the at least two lug features are cut into the curl. In some embodiments, the raised rim has a height no greater than about 0.6 inches above the center panel. In various embodiments, the metallic dispensing lid is comprised of an aluminum alloy and the aluminum alloy is blended from at least 20% of a recycled aluminum alloy. In some embodiments, the recycled aluminum alloy consists of a plurality of metals including aluminum and two or more of the following: silicon, iron, copper, manganese, magnesium, zinc, titanium, or chromium. In some embodiments, the lid further comprises a vent hole in the center panel.

In one embodiment, a metallic dispensing lid is provided comprising: a center panel; a sidewall interconnected to a perimeter of the center panel, the sidewall extending upwardly from the center panel between about 0.1 inch and 0.2 inch; a raised rim interconnected to the sidewall having a radius of curvature of between about 0.04 inch and about 0.08 inch; a curl interconnected to an outer portion of the raised rim and positioned below the raised rim and having a radius of curvature between about 0.025 inch and 0.06 inch; and at least two lug features formed in the curl which are biased inwardly and are configured to selectively secure and release the lid to a cup.

In some embodiments, the at least two lug features had an inwardly oriented curl to shroud the end of the curl to prevent contact with a user's fingers. In some embodiments, the inwardly oriented curl has a radius of curvature between about 0.015 inch and 0.045 inch. In various embodiments, the metallic dispensing lid further comprises a liner portion extending outwardly from the inwardly oriented curl which has a length of at least 0.1 inches to provide an engagement surface for a user's fingers. In some embodiments, the inwardly oriented curl extends inwardly at least about one third of a horizontal distance of the raised rim.

In one embodiment, a method of manufacturing a metallic dispensing lid is provided comprising: providing a coil of aluminum material; forming a blank of aluminum material which has a generally circular shape; feeding the blank into a cupper to form a lid shape with a center panel, an inner sidewall extending upwardly from the center panel, a raised rim interconnected to the inner sidewall that has a radius of curvature of between about 0.025 inch and 0.06 inch and forming a curl around a perimeter of the lid which extends downwardly from the raised rim; forming one or more lug features in the curl; and piercing the center panel to form one or more dispensing holes.

In some embodiments, the method further comprises: stacking a plurality of lids; bagging the plurality of lids; and palletizing the bags of lids for transportation. In various embodiments, the lids are coated on at least one of an exterior and interior surface after forming one or more lug features. In some embodiments, the method further comprises forming an inwardly oriented curl in the lug features to shroud the end of the lug from exposure.

Containers, including single-use cups, that can be used with embodiments of the novel lids disclosed herein include the cups described in U.S. Patent Publication No. 2018/0221936, entitled “Tapered Metal Cup and Method of Forming the Same,” and U.S. Patent Publication No. 2019/0112100, entitled “Tapered Metal Cup and Method of Forming the Same,” both of which are incorporated by reference herein in their entireties.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1 is a top perspective view of a first embodiment of the lid;

FIG. 2 is a bottom perspective view of the lid;

FIG. 3 is a front elevation view of the lid, the right, left, and rear elevation views being substantially the same as the front elevation view;

FIG. 4 is a top plan view of the lid;

FIG. 5 is a bottom plan view of the lid;

FIG. 6 is a cross-sectional front elevation view of the lid taken at the line 6-6 in

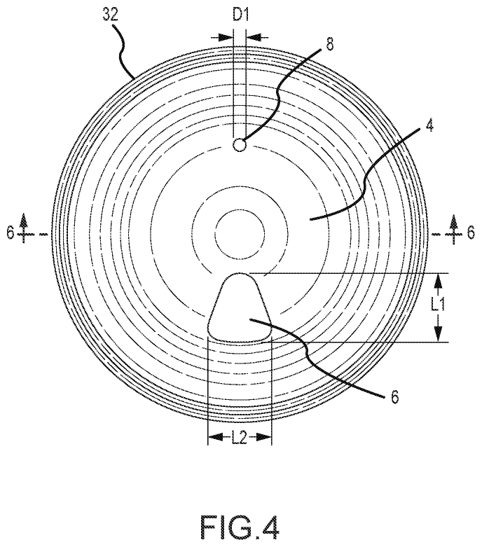

FIG. 4;

FIG. 7 is a perspective view of the lid connected to a cup;

FIG. 8 is a front elevation view of the lid and cup, the right, left, and rear elevation views being substantially the same as the front elevation view;

FIG. 9 is a top plan view of the lid and cup;

FIG. 10 is a bottom plan view of the lid and cup;

FIG. 11 is an exploded perspective view of the lid and cup;

FIG. 12 is a top perspective view of a second embodiment of a lid;

FIG. 13 is a bottom perspective view of the lid;

FIG. 14 is a front elevation view of the lid, the right, left, and rear elevation views being substantially the same as the front elevation view;

FIG. 15 is a top plan view of the lid;

FIG. 16 is a bottom plan view of the lid;

FIG. 17 is a cross-sectional front elevation view of the lid taken at the line 17-17 in FIG. 15;

FIG. 18 is a perspective view of the lid of FIG. 12 connected to a cup;

FIG. 19 is a front elevation view of the lid and cup, the right, left, and rear elevation views being substantially the same as the front elevation view;

FIG. 20 is a top plan view of the lid and cup;

FIG. 21 is a bottom plan view of the lid and cup;

FIG. 22 is an exploded front view of the lid and cup;

FIG. 23 is a top perspective view of a third embodiment of a lid;

FIG. 24 is a bottom perspective view of the lid;

FIG. 25 is a front elevation view of the lid, the right, left, and rear elevation views being substantially the same as the front elevation view;

FIG. 26 is a top plan view of the lid;

FIG. 27 is a bottom plan view of the lid;

FIG. 28 is a cross-sectional front elevation view of the lid taken at the line 28-28 in FIG. 26;

FIG. 29 is a perspective view of the lid of FIG. 23 interconnected to a cup;

FIG. 30 is a front elevation view of the lid and cup, the right, left, and rear elevation views being substantially the same as the front elevation view;

FIG. 31 is a top plan view of the lid and cup;

FIG. 32 is a bottom plan view of the lid and cup;

FIG. 33 is an exploded front view of the lid and cup.

FIG. 34 is a top perspective view of a fourth embodiment of a lid;

FIG. 35 is a bottom perspective view of the lid;

FIG. 36 is a front elevation view of the lid, the right, left, and rear elevation views being substantially the same as the front elevation view;

FIG. 37 is a top plan view of the lid;

FIG. 38 is a bottom plan view of the lid;

FIG. 39 is a cross-sectional front elevation view of the lid taken at the line 39-39 in FIG. 37;

FIG. 39A is an enlarged view of the lug feature shown in cross-section without a cup

FIG. 39B is an enlarged view of the lug feature shown with a cup attached to the lid;

FIG. 39C is a cross-sectional view of a portion of the lid connected to the upper end of a cup;

FIG. 40 is a perspective view of the lid interconnected to a cup;

FIG. 41 is a front elevation view of the lid and cup, the right, left, and rear elevation views being substantially the same as the front elevation view;

FIG. 42 is a top plan view of the lid and cup;

FIG. 43 is a bottom plan view of the lid and cup;

FIG. 44 is an exploded front view of the lid and cup;

FIG. 45 is a top perspective view of a fifth embodiment of a lid;

FIG. 46 is a bottom perspective view of the lid;

FIG. 47 is a front elevation view of the lid, the right, left, and rear elevation views being substantially the same as the front elevation view;

FIG. 48 is a top plan view of the lid;

FIG. 49 is a bottom plan view of the lid;

FIG. 50 is a cross-sectional front elevation view of the lid taken at the line 50-50 in FIG. 48;

FIG. 50A is an enlarged view of the lug feature shown in cross-section with a cup;

FIG. 50B is an enlarged, cross-sectional elevation view taken through a portion of the lid without the lug features;

FIG. 51 is a perspective view of the lid interconnected to a cup;

FIG. 52 is a front elevation view of the lid and cup, the right, left, and rear elevation views being substantially the same as the front elevation view;

FIG. 53 is a top plan view of the lid and cup;

FIG. 54 is a bottom plan view of the lid and cup;

FIG. 55 is an exploded front view of the lid and cup;

FIG. 56 is a top perspective view of a sixth embodiment of a lid;

FIG. 57 is a bottom perspective view of the lid;

FIG. 58 is a front elevation view of the lid, the right, left, and rear elevation views being substantially the same as the front elevation view;

FIG. 59 is a top plan view of the lid;

FIG. 60 is a bottom plan view of the lid;

FIG. 61 is a cross-sectional front elevation view of the lid taken at the line 61-61 in FIG. 59;

FIG. 61A is an enlarged view of the lug feature shown in cross-section without a cup;

FIG. 61B is an enlarged view of the lug feature shown with a cup attached to the lid;

FIG. 61C is a cross-sectional view of a portion of the lid connected to the upper end of a cup;

FIG. 62 is a perspective view of the lid of FIG. 56 connected to a cup;

FIG. 63 is a front elevation view of the lid and cup, the right, left, and rear elevation views being substantially the same as the front elevation view;

FIG. 64 is a top plan view of the lid and cup;

FIG. 65 is a bottom plan view of the lid and cup;

FIG. 66 is an exploded perspective view of the lid and cup;

FIG. 67 is a top perspective view of a seventh embodiment of a lid;

FIG. 68 is a bottom perspective view of the lid;

FIG. 69 is a front elevation view of the lid, the right, left, and rear elevation views being substantially the same as the front elevation view;

FIG. 70 is a top plan view of the lid;

FIG. 71 is a bottom plan view of the lid;

FIG. 72 is a cross-sectional front elevation view of the lid taken at the line 72-72 in FIG. 70;

FIG. 72A is an enlarged view of the lug feature shown in cross-section with a cup;

FIG. 72B is a cross-sectional elevation view taken through a portion of the lid without the lug features, i.e., taken at the line B-B in FIG. 70;

FIG. 72C is an enlarged top plan view of the pour opening and lug feature of the lid of FIG. 69;

FIG. 73 is a perspective view of the lid interconnected to a cup;

FIG. 74 is a front elevation view of the lid and cup, the right, left, and rear elevation views being substantially the same as the front elevation view;

FIG. 75 is a top plan view of the lid and cup;

FIG. 76 is a bottom plan view of the lid and cup;

FIG. 77 is an exploded front perspective view of the lid and cup;

FIG. 78 is a flow chart of one embodiment of the production flow to produce the lid;

FIG. 79 is a flow chart of another embodiment of the production flow to produce the lid;

FIG. 80 is a flow chart of another embodiment of the production flow to produce the lid;

FIG. 81 is a flow chart of another embodiment of the production flow to produce the lid; and

FIG. 82 is a flow chart of another embodiment of the production flow to produce the lid.

To assist in the understanding of the embodiments of the present invention, the following list of components and associated numbering found in the drawings is provided herein:

| Numeral | Component Name |
|---|---|
| 2 | Lid |
| 4 | Center panel |
| 6 | Dispensing orifice |
| 8 | Vent hole |
| 10 | Raised rim |
| 20 | Chuck wall |
| 22 | Lip contour |
| 24 | Dip/recessed portion or lowest point of center panel |
| 26 | Countersink inner wall |
| 28 | Countersink |
| 30 | Countersink outer wall |
| 32 | Curl |
| 40 | Cup |
| 42 | Tapered portion/rib |
| 44 | Curl of cup |
| 46 | Cup upper end |
| 48 | Bottom of cup |
| 50 | Body of cup |
| 52 | Side wall |
| 54 | Opening |
| 56 | Inner surface of sidewall |
| 58 | Outer surface of sidewall |
| 70 | Sidewall inner surface |
| 72 | Sidewall outer surface |
| 74 | Domed portion |
| 76 | Bottom surface of center panel |
| 78 | Upper/outer surface of center panel |
| 80 | Straight portion of sidewall |
| 82 | Curved portion of sidewall |
| 84 | Sidewall of lid |
| 86 | Top of lid |
| 88 | Bottom of lid |
| 100 | Inner sidewall |
| 102 | Outer sidewall (also vertical sidewall) |
| 104 | Horizontal portion or flange |
| 106 | Vertical portion of inner sidewall |
| 108 | Curved inner sidewall |
| 110 | Lower sidewall |
| 112 | Sidewall inner surface |
| 114 | Sidewall outer surface |
| 120 | Lug feature |
| 122 | Dimple or protuberance |
| 124 | Curved/rounded corner (of lid)/shoulder |
| 126 | Upper/outer curved portion of lug |
| 128 | Linear portion of lug |
| 130 | Inner curved portion of lug |
| 132 | End |
| 134 | Transitional portion |
| H1 | Height of lid |
| H2 | Height of lid curl |
| H3 | Height from bottom of lid curl to top of shoulder/flange |
| H4 | Height of countersink to top of curl |
| H5 | Height of dip/recessed portion to raised rim |
| H6 | Height of domed portion/drain back portion |
| H7 | Height of straight portion of lid sidewall |
| H8 | Height of flange to raised rim |
| H9 | Height of lug feature |
| RH | Retention height |
| R1 | Cup curl radius of curvature |
| R2 | Lid corner radius of curvature |
| R3 | Lug inner radius of curvature |
| R4 | Lug outer radius of curvature |
| R5 | Lid curl radius of curvature |
| R6 | Raised rim top radius of curvature |
| R7 | Raised rim lip contour radius of curvature |
| R8 | Raised rim shoulder radius of curvature |
| R9 | Dip/recessed portion radius of curvature |
| R10 | Dip/recessed portion corner radius of curvature |
| L1 | Dispensing orifice length (vertical) |
| L2 | Dispensing orifice length (horizontal) |
| L3 | Lug length |
| L4 | Lug transition length |
| A1 | Angle from bottom of curl to top of lug |
| A2 | Angle from top to bottom of lug |
| D1 | Diameter of vent hole |
| D2 | Diameter of raised rim portion of lid |
| D3 | Diameter of countersink inner wall |
| D4 | Diameter of raised rim outer sidewall |
| D5 | Diameter of outer sidewall |
| D6 | Diameter of dome/drain back feature |
| D7 | Diameter of raised rim inner sidewall |
| OD | Outer diameter of lid |
| ID | Inner diameter of lid |

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein. The accompanying drawings, which are incorporated in and constitute a part of the specification, illustrate embodiments of the invention and together with the general description of the invention given above and the detailed description of the drawings given below, serve to explain the principles of the invention.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein. Moreover, features of one embodiment can be combined with features of another embodiment herein without departing from the scope of the invention. To avoid duplicative and unnecessary description herein, not all combinations of the various embodiments are described. However, such combinations are expressly included in this application and are within the scope of the present invention.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning.

Various embodiments of the present invention are described herein and as depicted in the drawings. It is expressly understood that although the figures depict metallic lids and cups, and methods and systems for using the same, the present invention is not limited to these materials. It should also be understood that the terms “cup” and “container”; “lid” and “cover”; “end closure” and “container end closure”; “dispensing orifice” and “pour opening”; “curled edge,” “curl,” “curled portion,” “peripheral curl,” and “lip”; “cup taper” and “cup rib”; “cup sidewall” and “cup body”; and “main” and “primary” may be used interchangeably in some instances.

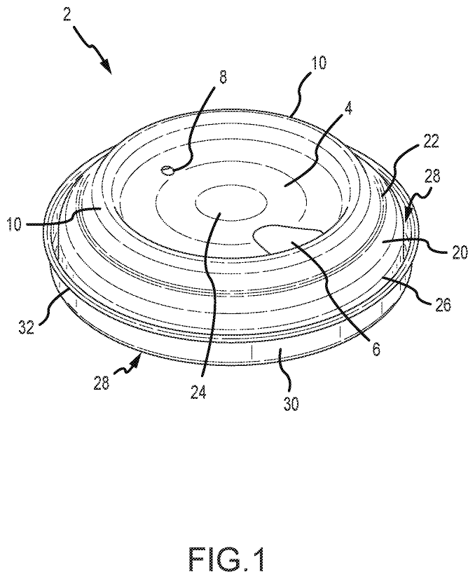

FIG. 1 is a top perspective view of a first embodiment of the lid 2. This lid 2 is designed for cold beverages, specifically iced coffees and other iced beverages, but can be used with warm drinks. The lid 2 includes a center panel 4 that may be substantially flat and substantially horizontal in some embodiments. In other embodiments, the center panel 4 may be curved or angled downward to form a domed shape or dip 24. The center panel 4 may include various other shapes to improve rigidity or customer-specific shapes, such as logos. Additionally, the center panel 4 can be decorated with customer specific artwork and/or logos. The center panel 4 comprises a dispensing orifice (also called a pour opening) 6 for dispensing liquids therethrough. The center panel 4 also has a vent hole 8 in some embodiments to improve fluid flow through the dispensing orifice 6 and for ease of pouring liquid out of the dispensing orifice 6. Interconnected to the perimeter of the center panel is a raised rim 10, which may be raised above the center panel 4 (measured from the top of the raised rim to the lowest point 24 of the center panel 4) a height between about 0.2 inches and about 0.6 inches. In a preferred embodiment, the top of the raised rim 10 is raised above the lowest point 24 of the center panel 4 a height of about 0.4 inches.

The raised rim 10 extends downwardly and away from the center panel forming a curved chuckwall 20, which interconnects to a countersink inner wall 26. The chuckwall 20 includes a lip contour 22 for a user's lips. The raised rim 10 and the curved chuckwall 20 are designed to accommodate a user's lips and provide a comfortable drinking experience. The raised rim 10 can also aid in residual liquid draining back into the dispensing orifice 6. The center panel 4 includes a dip or recessed portion 24 to accommodate a user's nose. The countersink inner wall 26 interconnects to the countersink 28. A countersink outer wall 30 extends upwardly from the countersink 28 and is interconnected on a top end to a curl 32. The curl 32 has a radius of curvature between about 0.03 inches and about 0.06 inches, which is selected for ease of manufacturing. Alternatively, the curl 32 could have a larger radius of curvature such that the lid 2 is easier to remove from the cup, if functionality is more important than ease of manufacturing. For all embodiments of the lid 2 presented herein, the purpose of the curl 32 on the lid 2 is to hide the cut edge of the flange from the consumer such that the consumer does not cut his or her lip. The curl 32 also adds rigidity and creates a surface for the consumer to pull against when removing the lid 2 from the cup.

The countersink outer wall 30 is substantially vertical or angled slightly outward (i.e., at a slight angle relative to a vertical axis, meaning the top of the countersink outer wall 30 proximate the curl is slightly farther away from a center axis of the lid 2 than the bottom of the countersink outer wall 30 proximate the countersink 28) and is positioned adjacent to the inner wall of a cup when the lid 2 is interconnected to a cup. Thus, the outer diameter of the countersink outer wall 30 is approximately the same as or slightly larger than the inner diameter of the upper portion of the cup such that the countersink 28 (including the countersink inner wall 26 and countersink outer wall 30) provides spring pressure to secure the lid 2 to the cup. Specifically, when the user pushes the lid 2 down onto the cup, the countersink 28 deforms (i.e., is pushed inward) and the countersink 28 tries to push itself outward, which securely pushes the lid 2 against the cup.

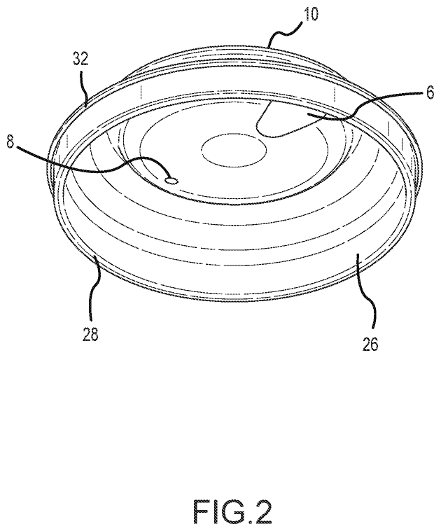

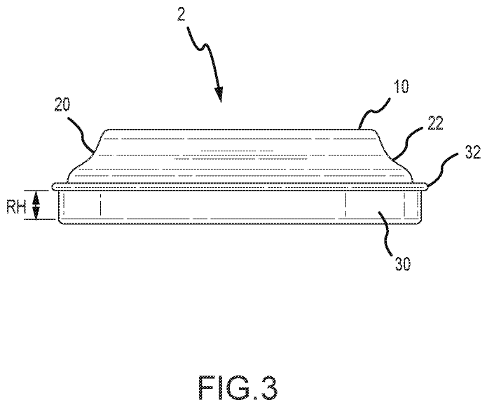

FIG. 2 is a bottom perspective view of the lid 2, showing the countersink 28 and countersink inner wall 26. FIG. 3 is a front elevation view of the lid 2, the right, left, and rear elevation views being substantially the same as the front elevation view. The lip contour 22 is easily seen in this view. Additionally, the retention height RH (also called retention length) is shown. This portion of the lid 2 creates the retention feature, which applies pressure to the inner diameter of the cup to securely hold the lid onto the cup. In some embodiments, the retention height RH is between about 0.25 inch and 0.3 inch, or about 0.25 inch, 0.26 inch, 0.27 inch, 0.28 inch, 0.282 inch, 0.29 inch, and 0.3 inch, or a range or value between two of these values. The term “about” can mean a variation of +/−10% on a relative basis. In a preferred embodiment, the retention height RH is about 0.2820 inch.

FIG. 4 is a top plan view of the lid 2. In some embodiments, the diameter D1 of the vent hole 8 is between about 0.08 inch and 0.12 inch, or 0.08 inch, 0.09 inch, 0.1 inch, 0.11 inch, and 0.12 inch, or a range or value between two of these values. In a preferred embodiment, the diameter D1 of the vent hole 8 is about 0.1 inch. In one embodiment, the length L1 in the radial direction of the dispensing orifice 6 is between about 0.5 inch and 1.0 inch, or 0.5 inch, 0.6 inch, 0.7 inch, 0.8 inch, 0.9 inch, and 1.0 inch, or a range or value between two of these values. In a preferred embodiment, the length L1 in the radial direction of the dispensing orifice 6 is about 0.7 inch. In one embodiment, the length L2 of the dispensing orifice 6 in the horizontal direction as shown in FIG. 4 is between about 0.4 inch and about 0.8 inch, or 0.4 inch, 0.5 inch, 0.6 inch, 0.7 inch, and 0.8 inch, or a range or value between two of these values. In a preferred embodiment, the length L2 of the dispensing orifice 6 in the horizontal direction as shown in FIG. 4 is about 0.6 inch.

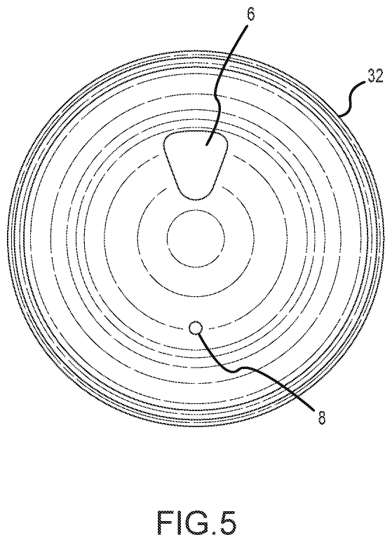

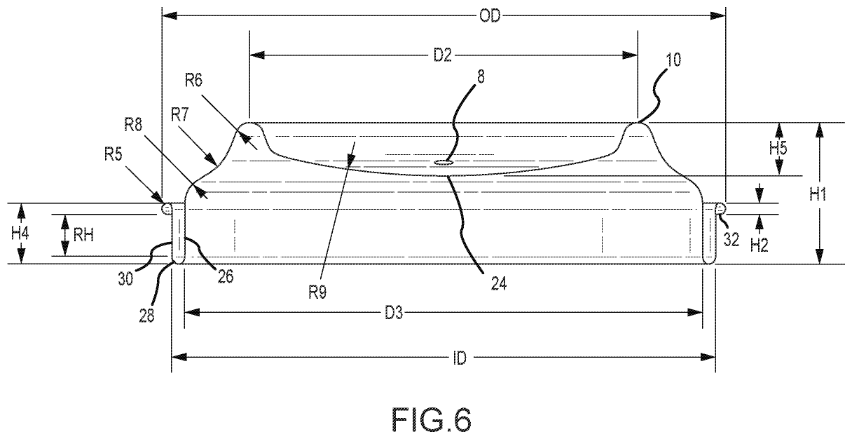

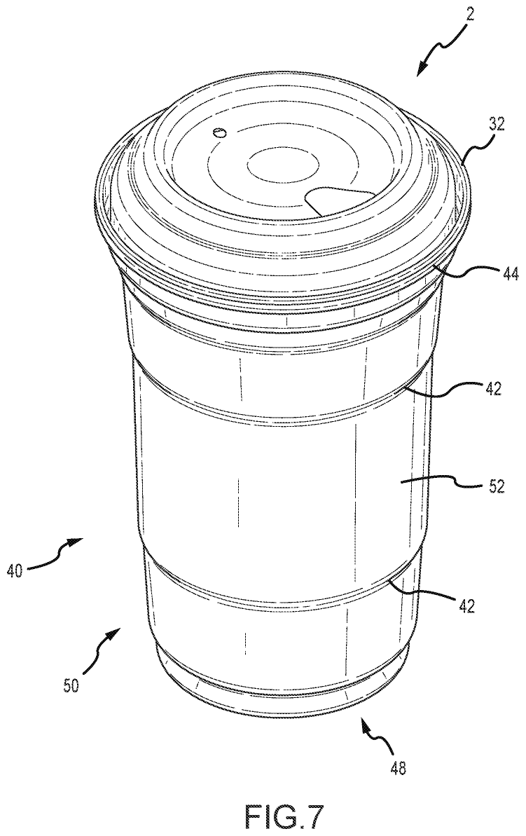

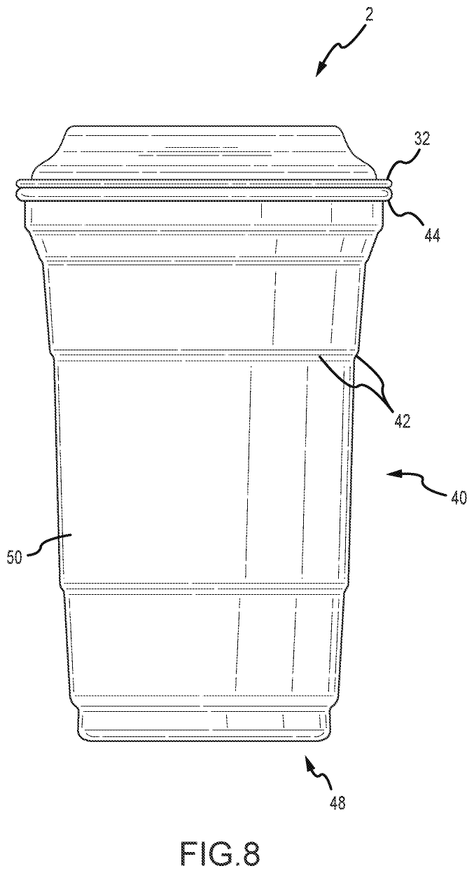

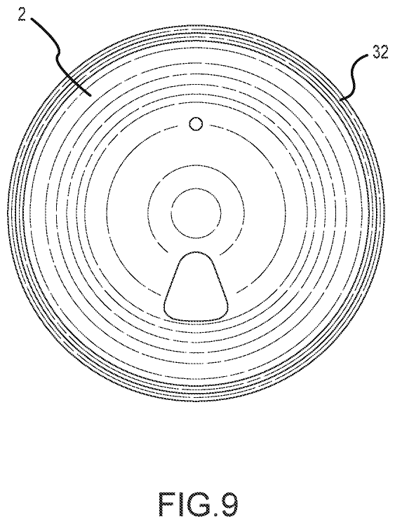

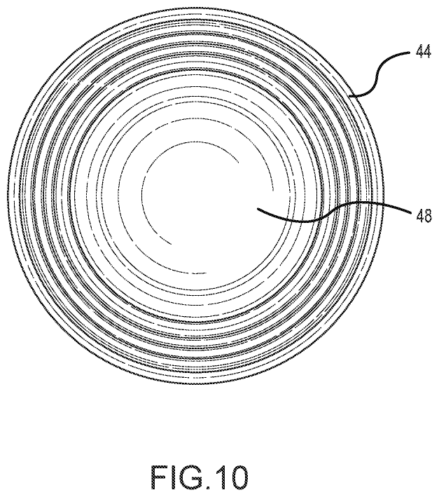

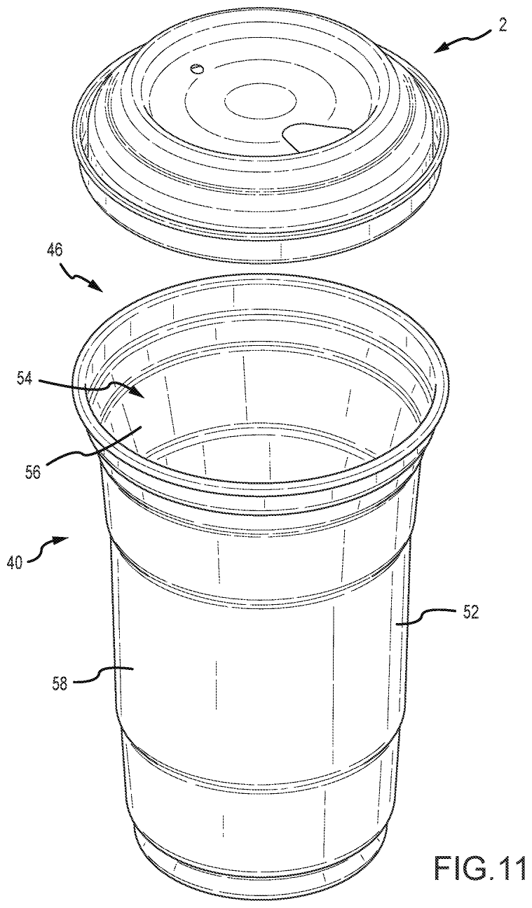

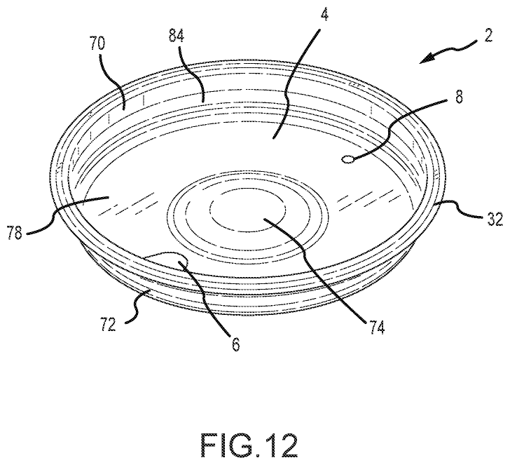

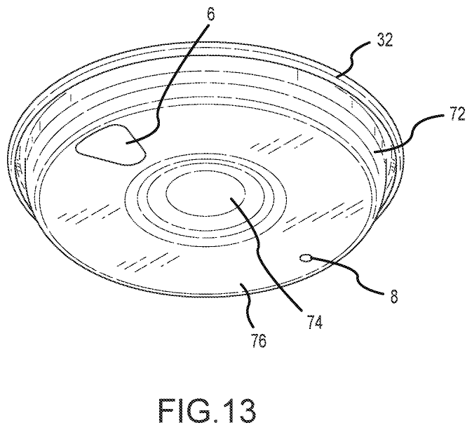

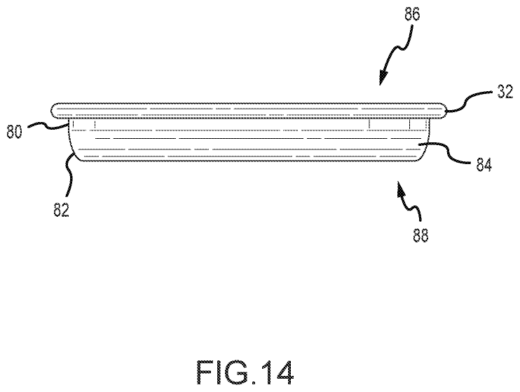

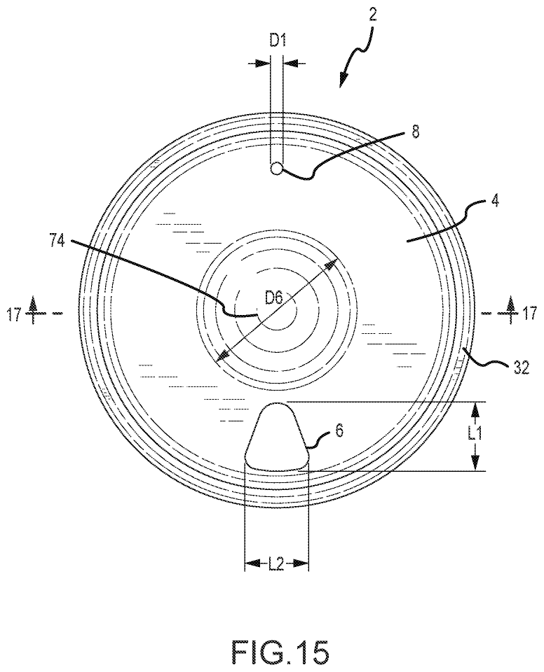

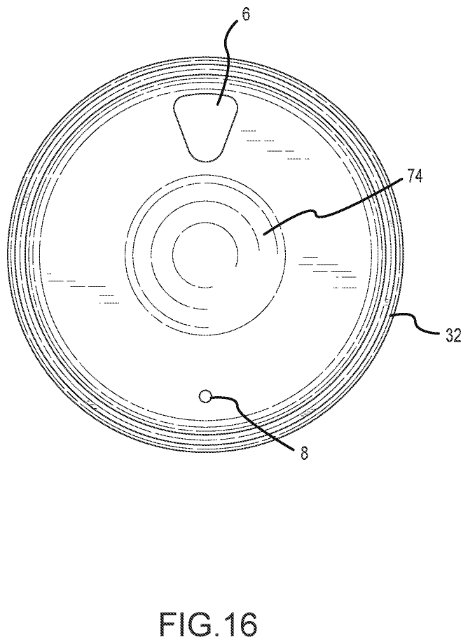

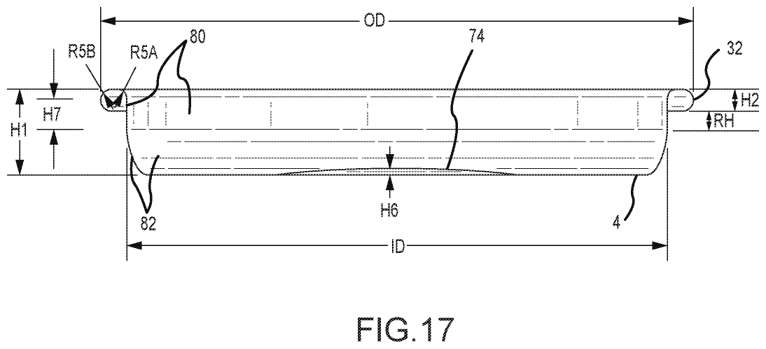

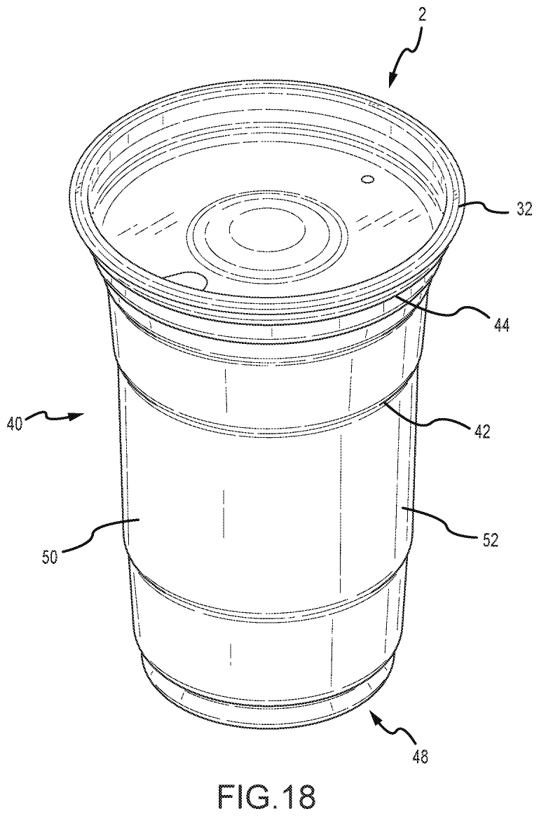

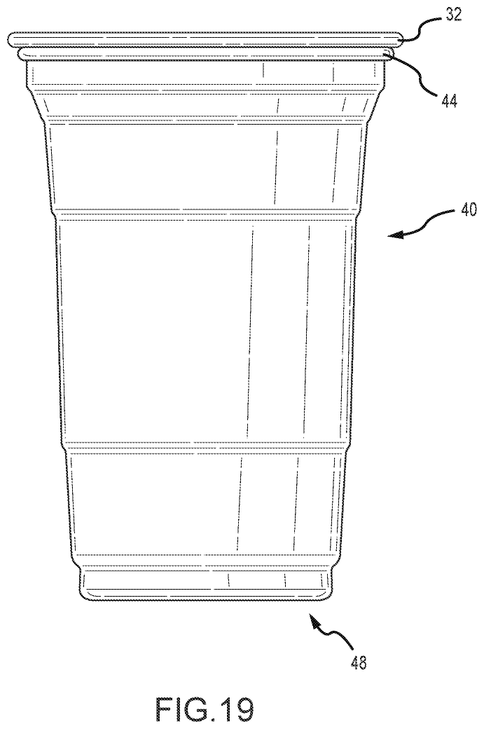

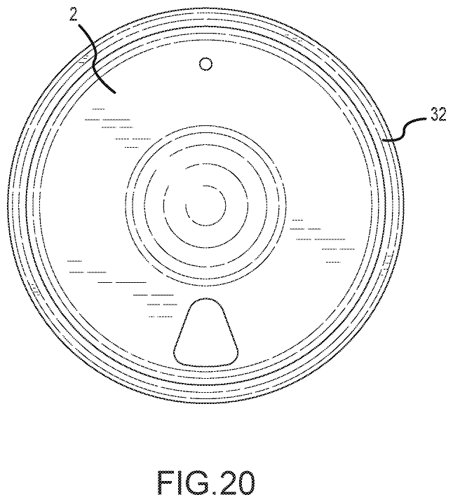

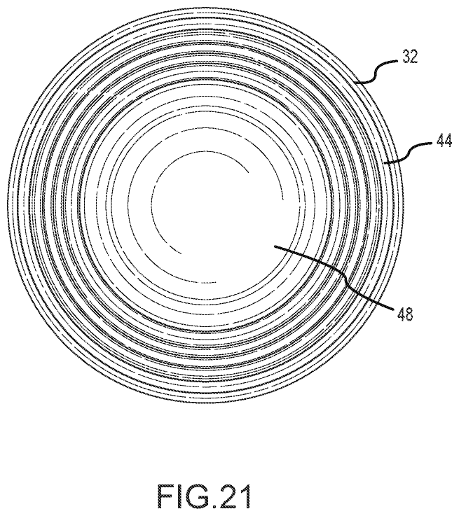

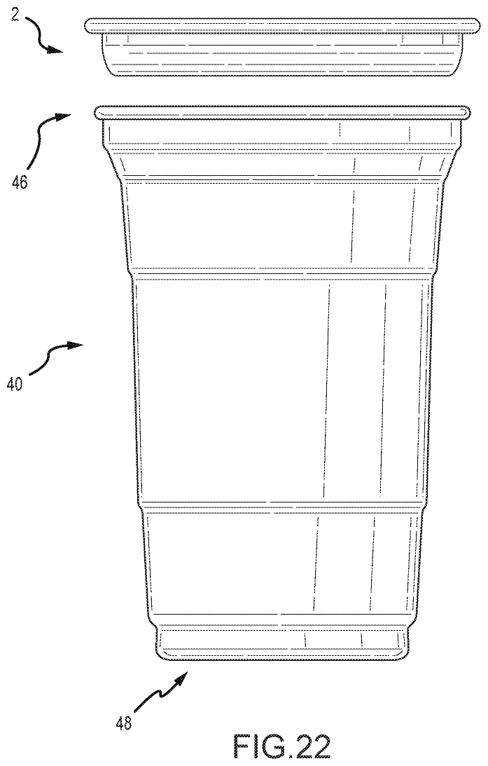

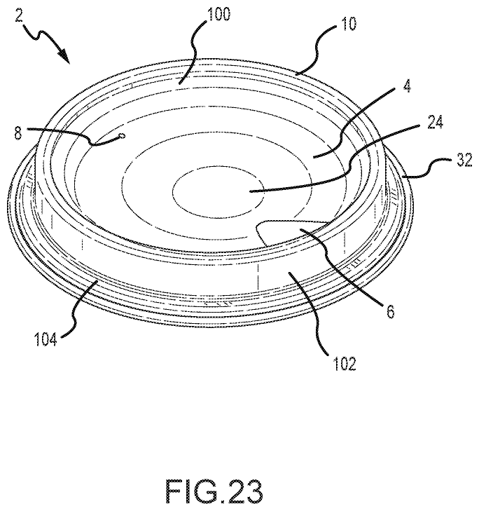

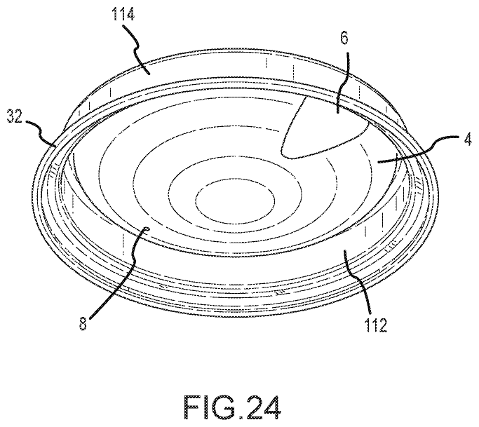

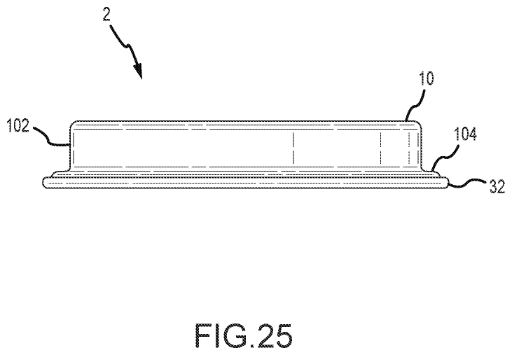

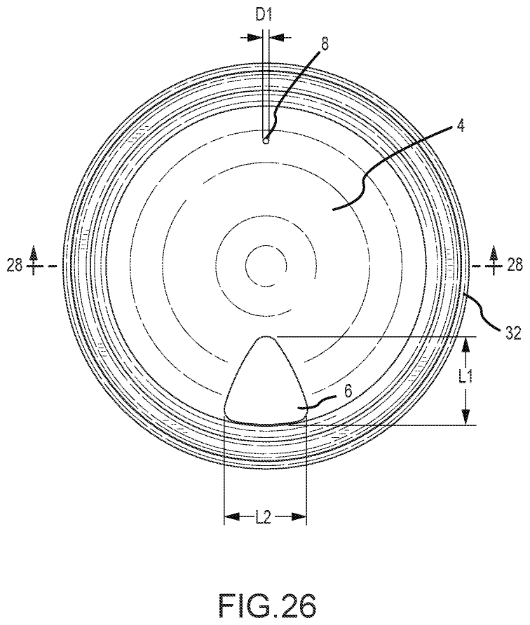

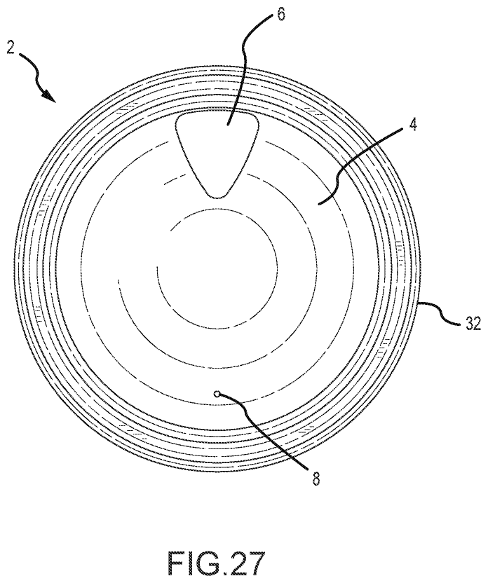

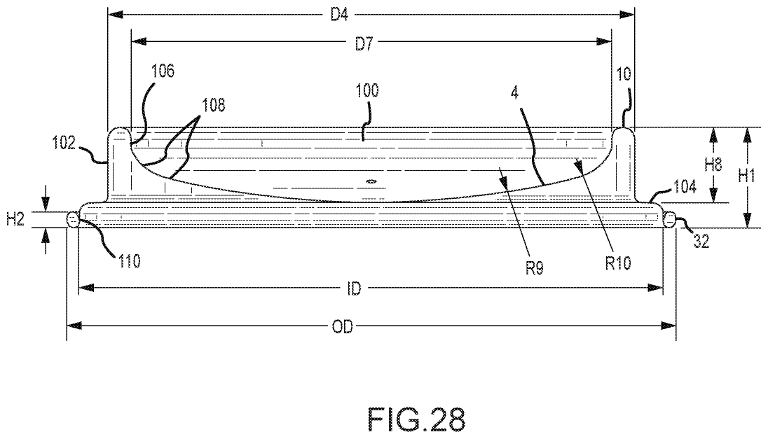

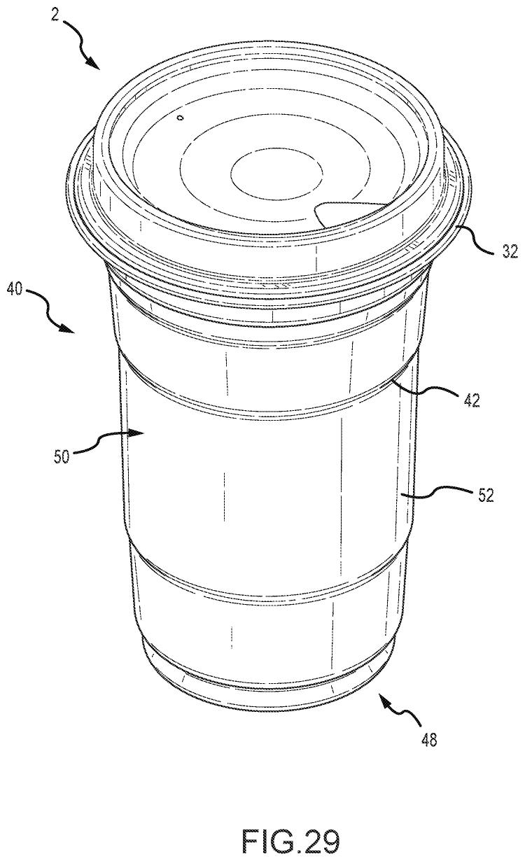

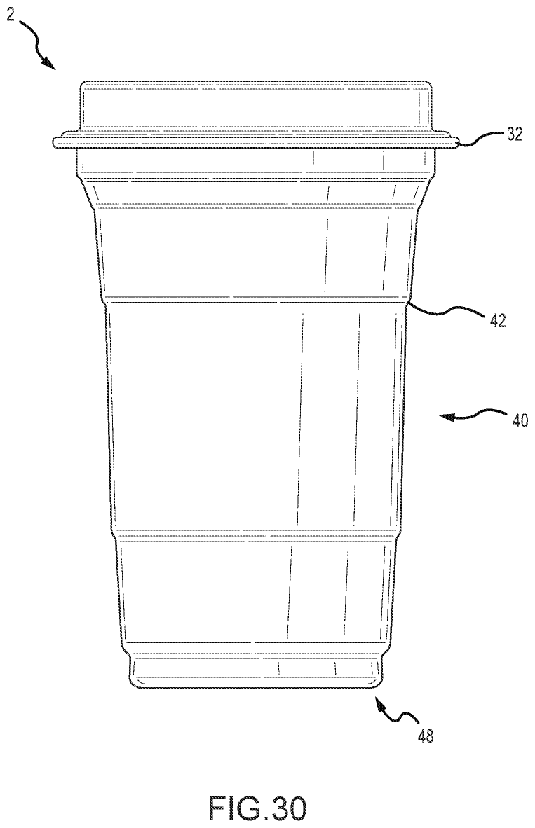

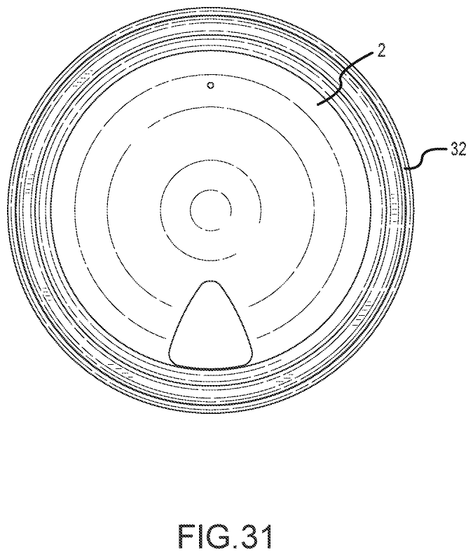

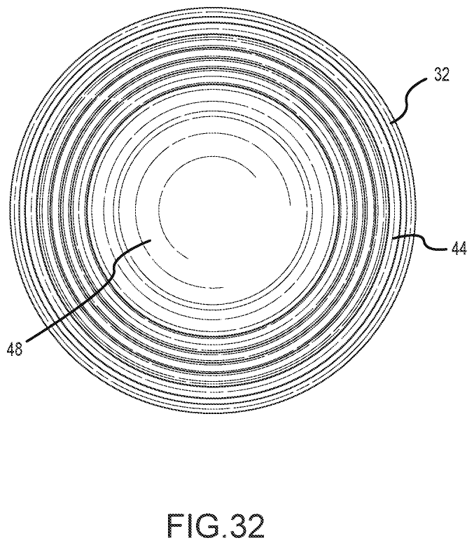

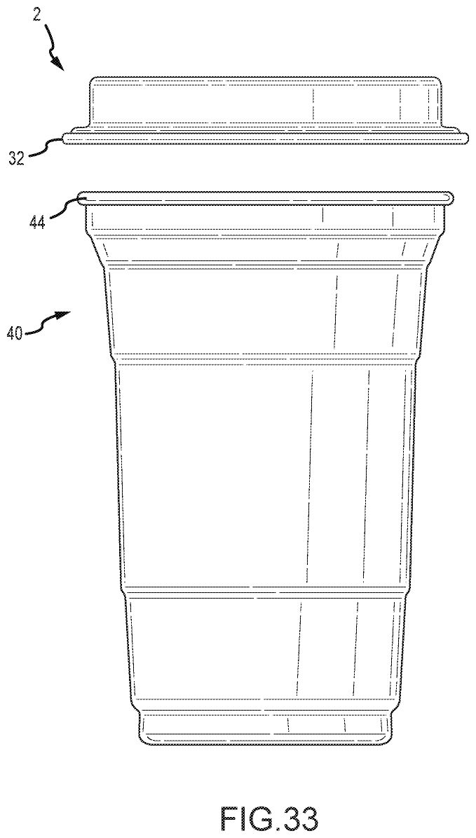

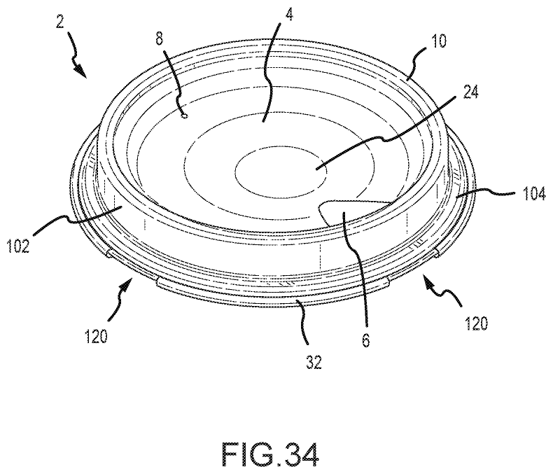

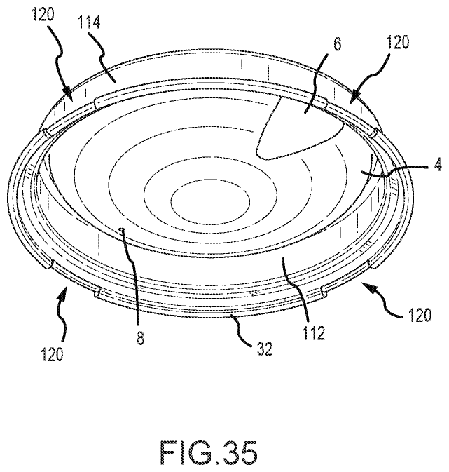

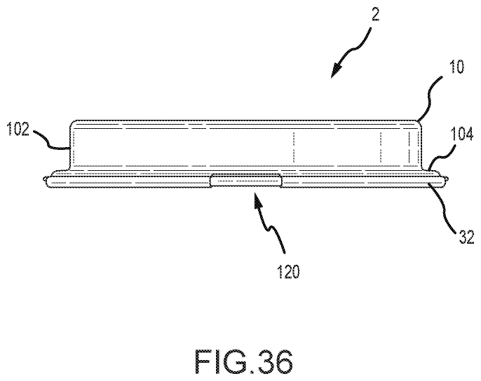

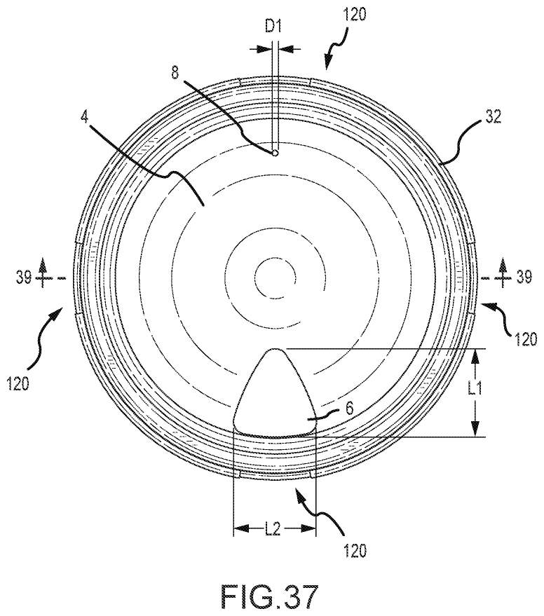

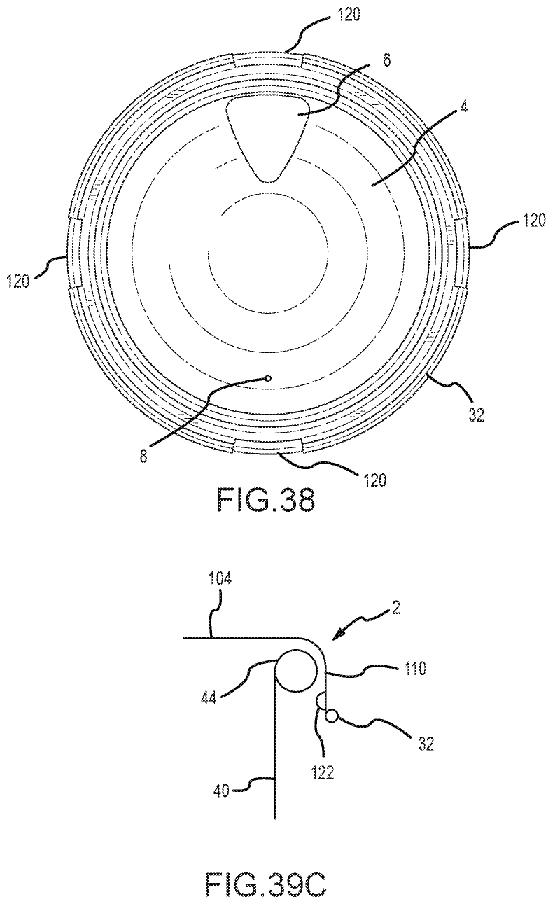

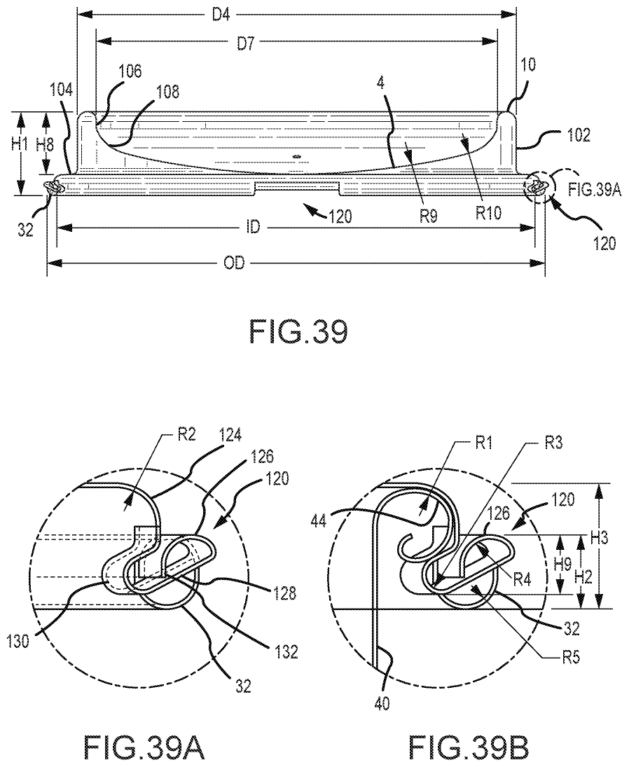

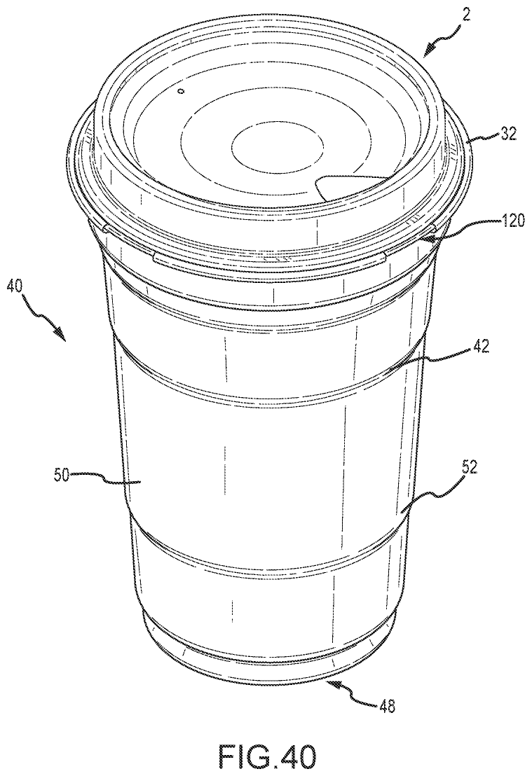

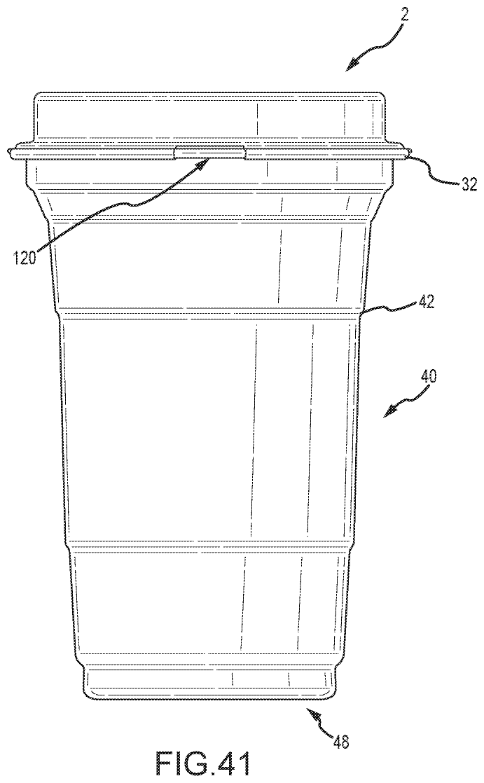

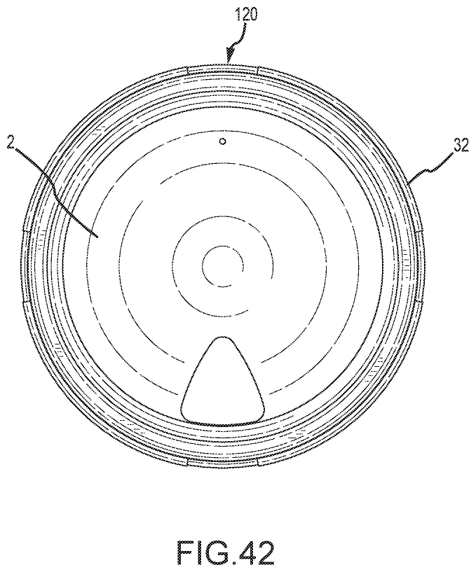

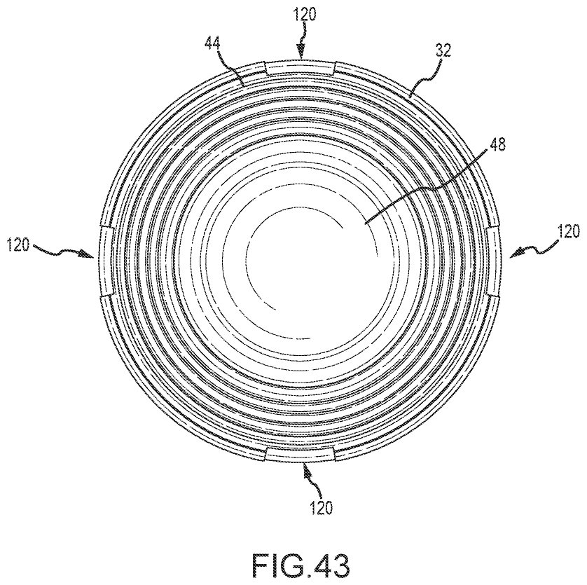

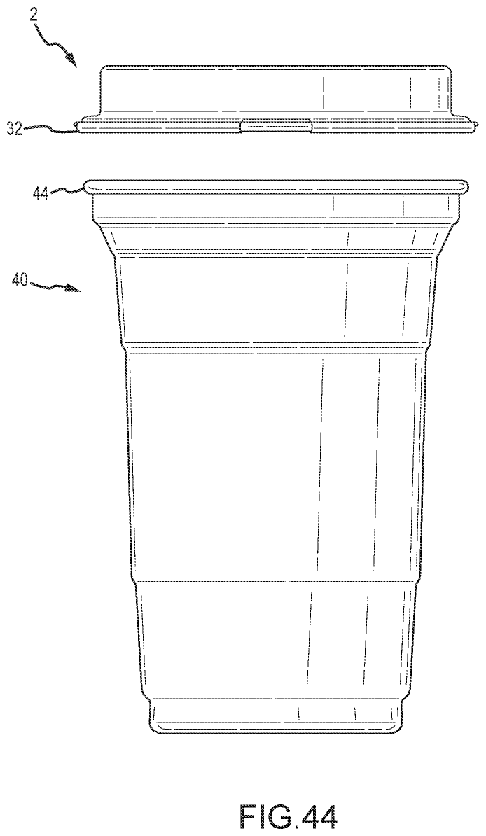

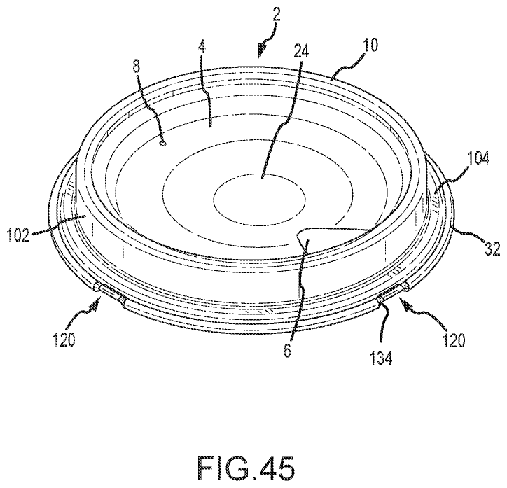

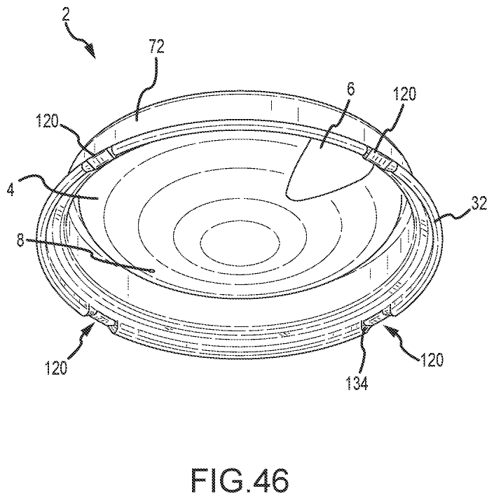

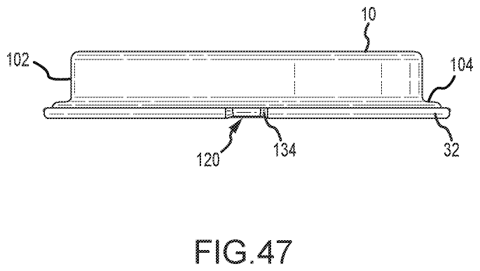

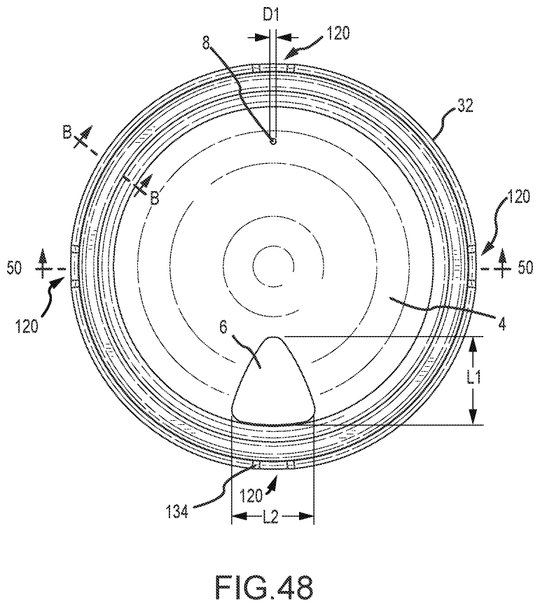

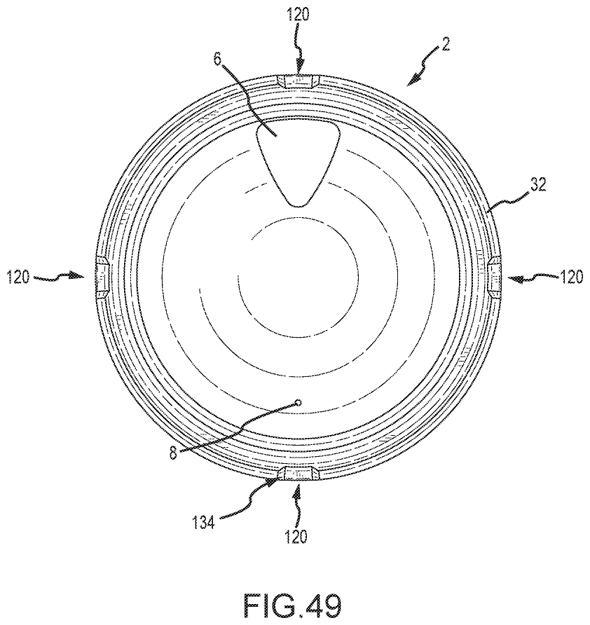

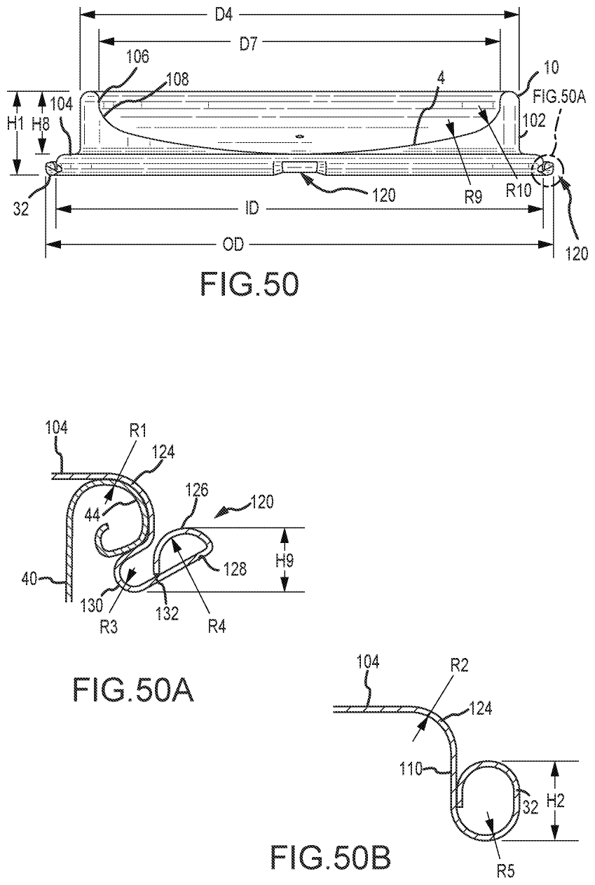

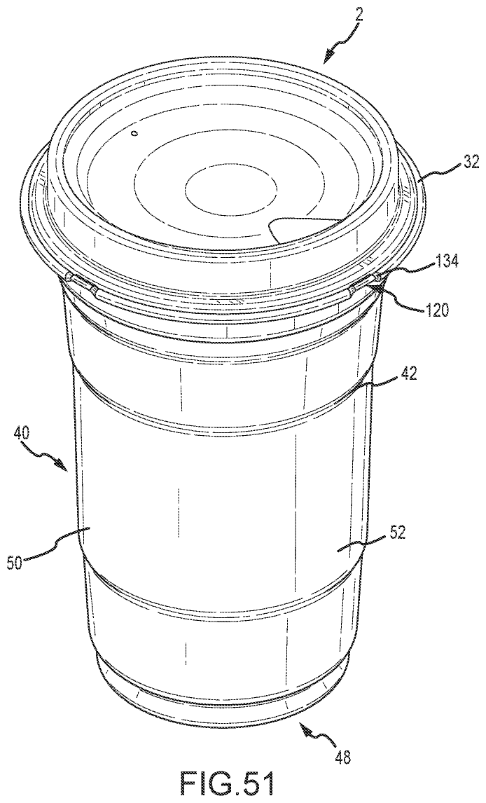

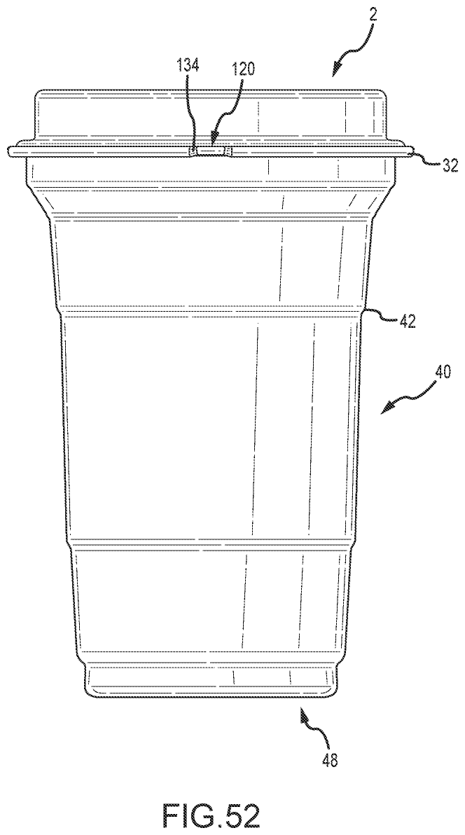

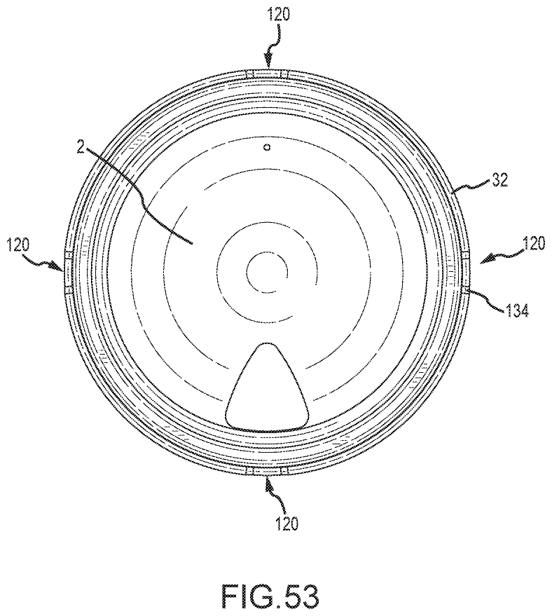

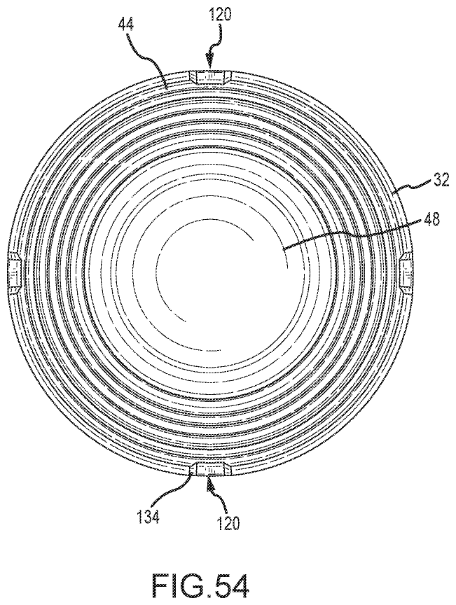

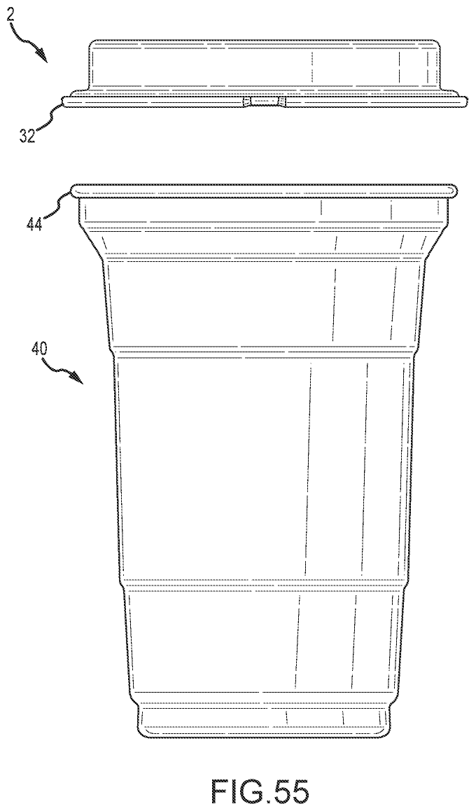

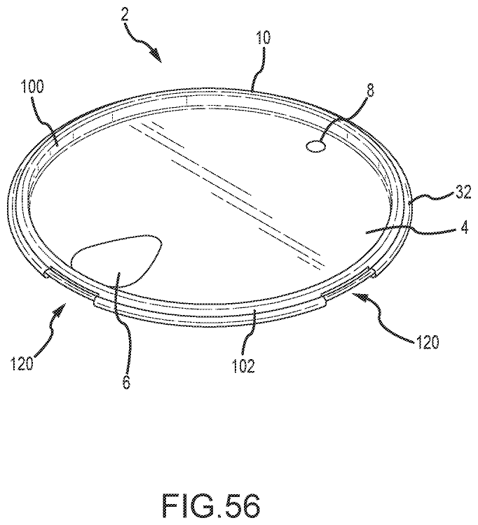

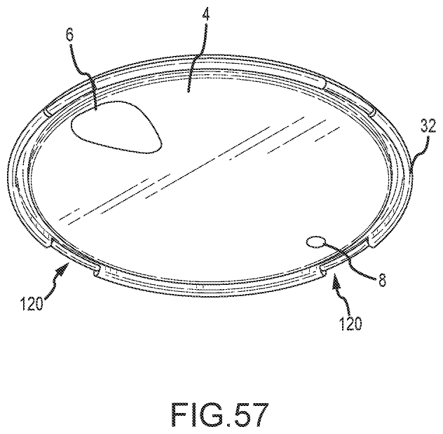

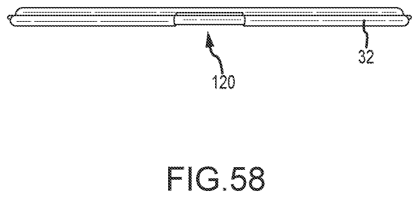

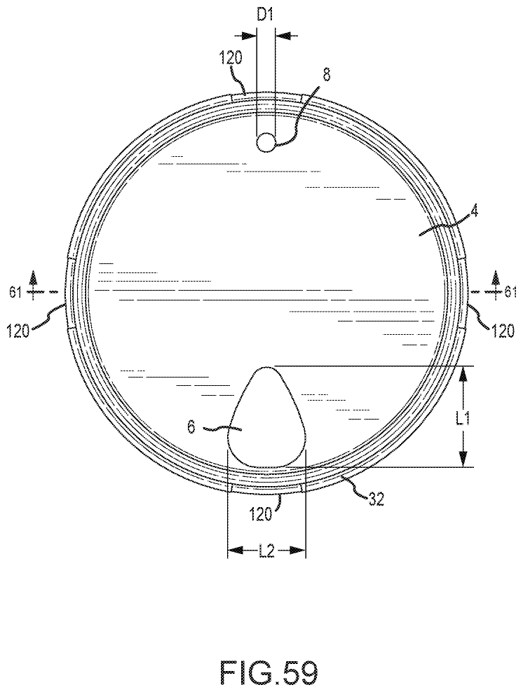

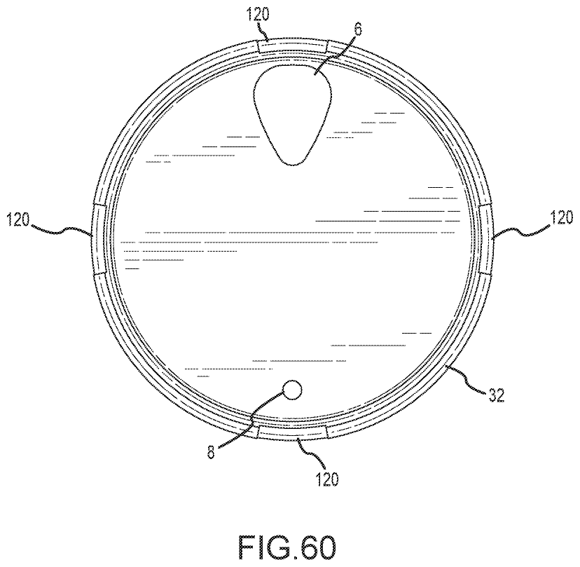

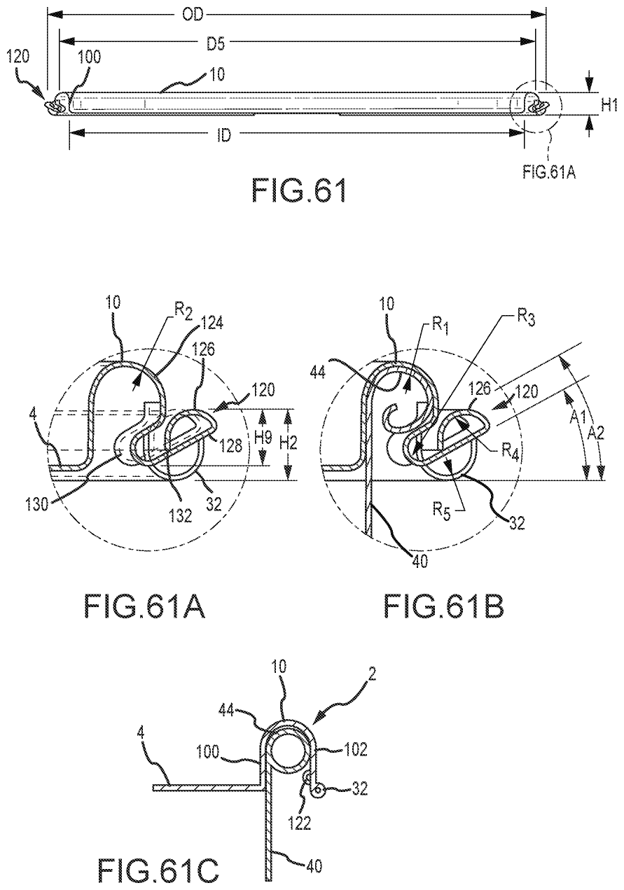

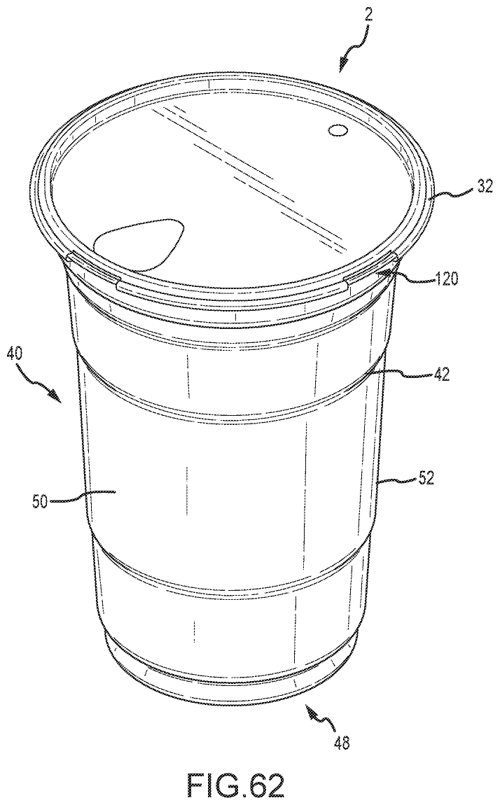

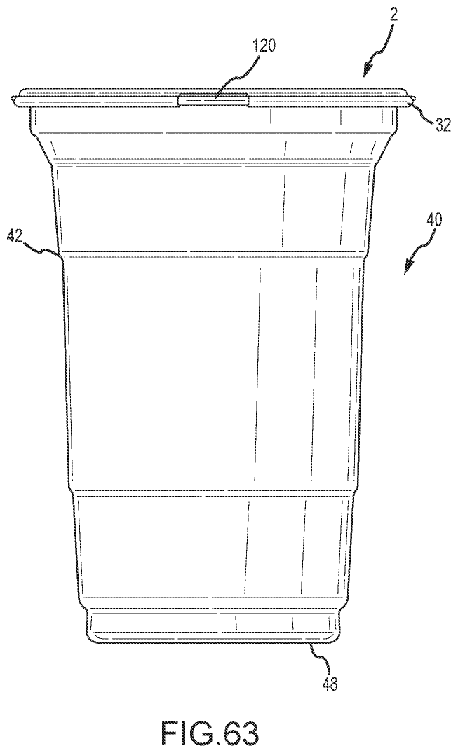

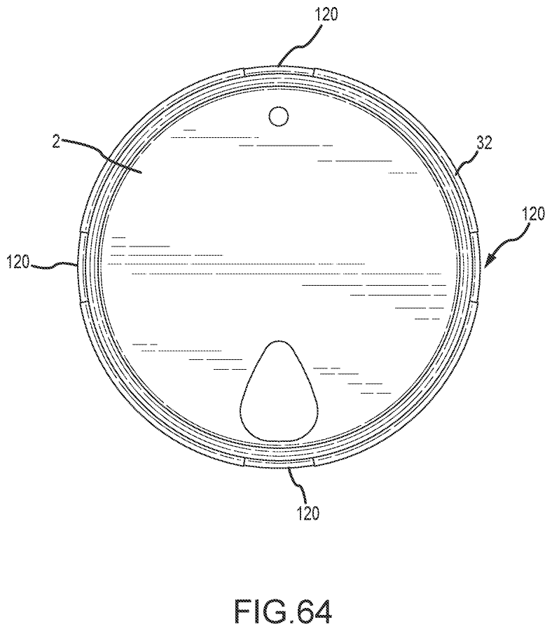

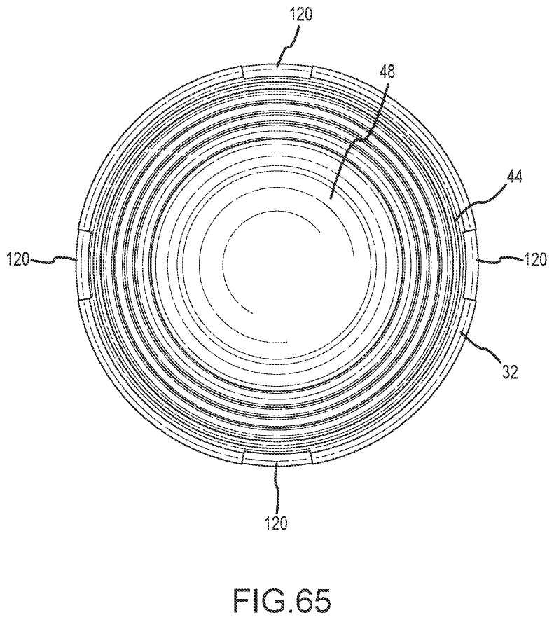

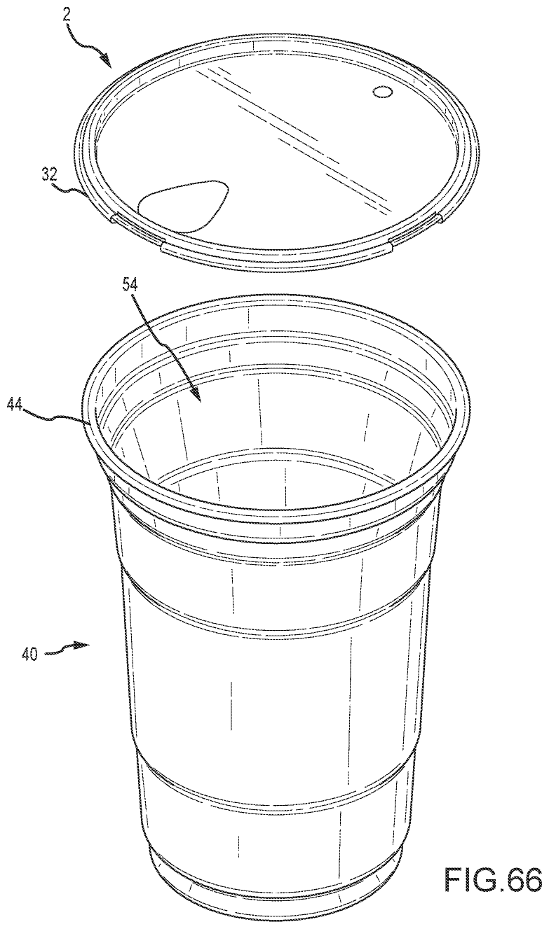

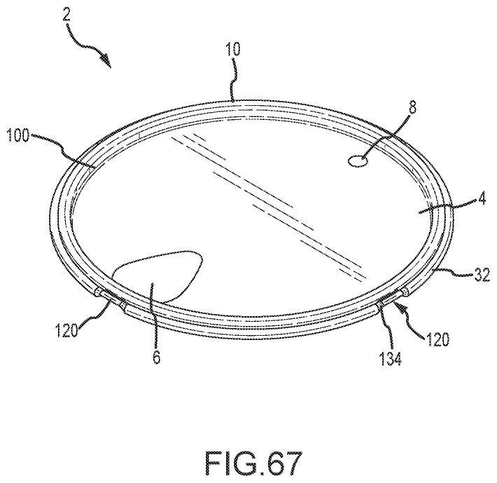

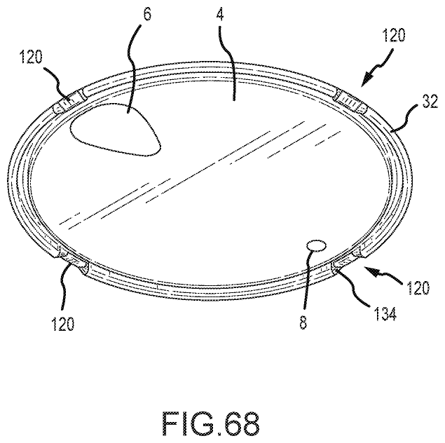

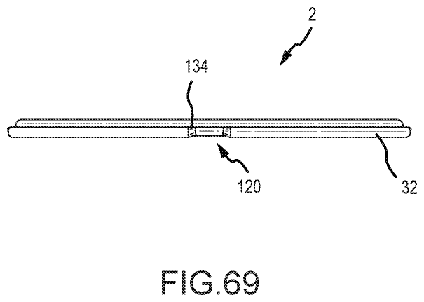

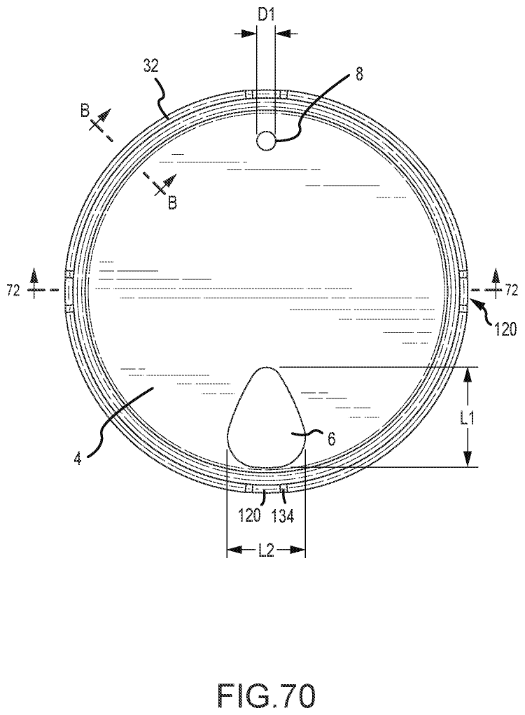

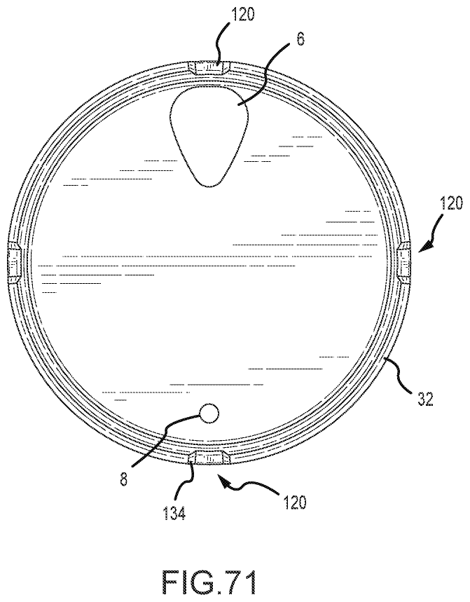

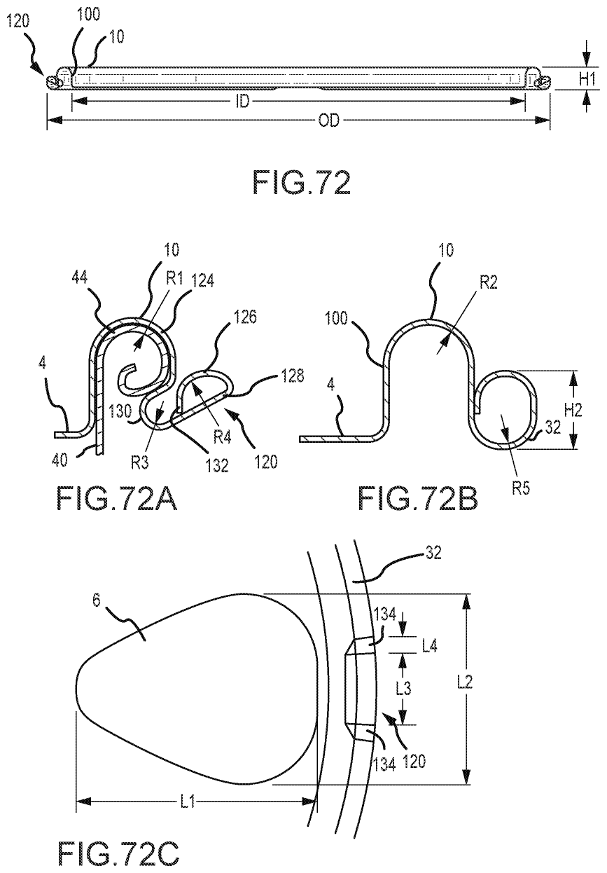

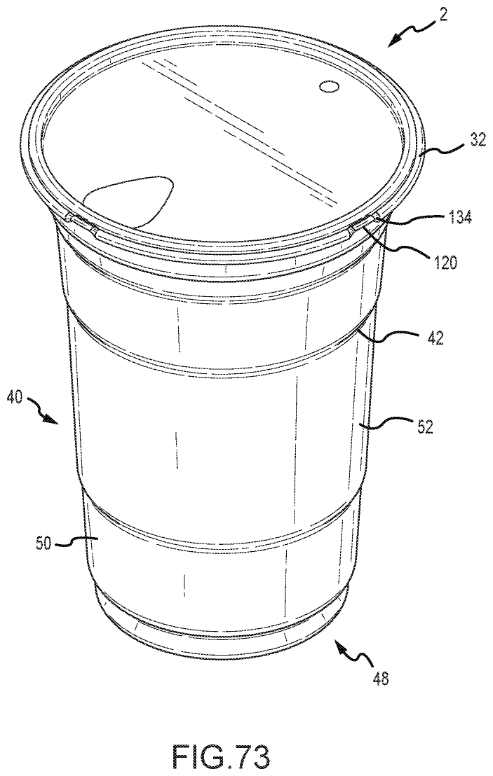

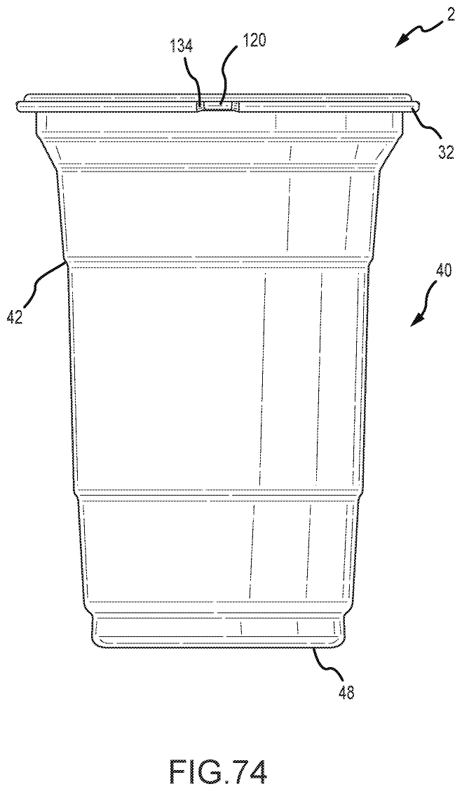

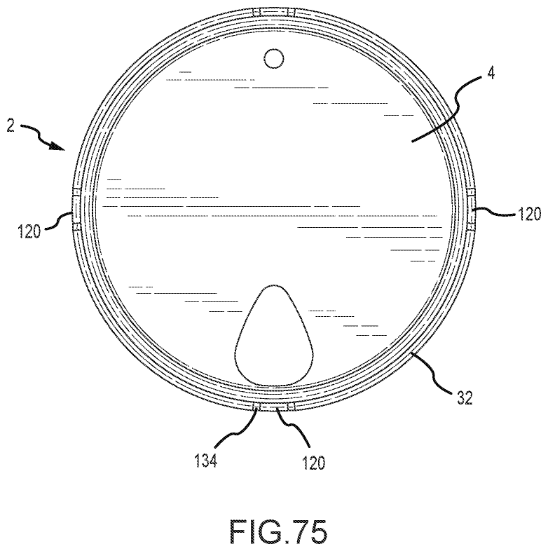

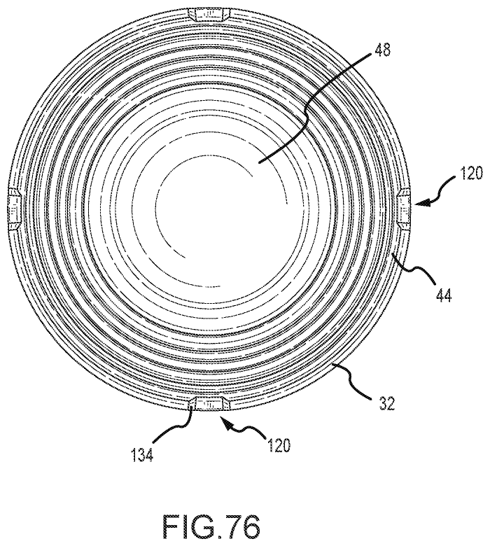

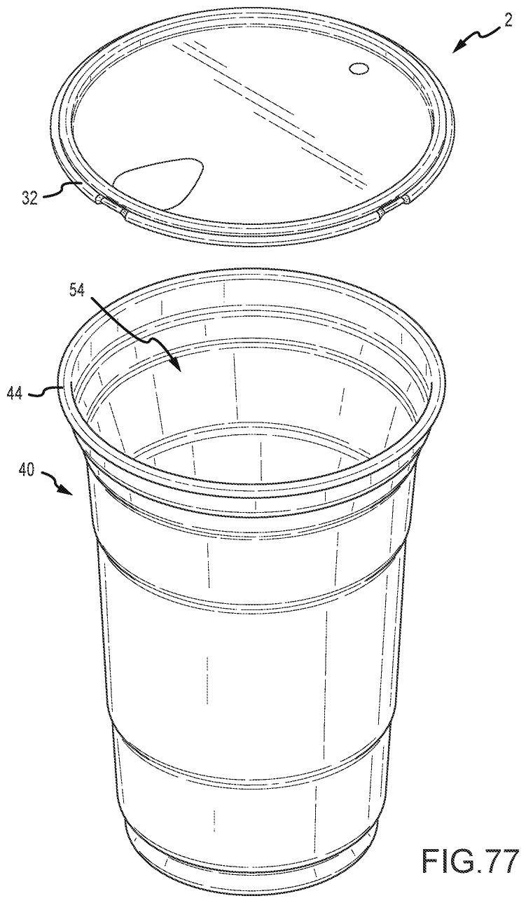

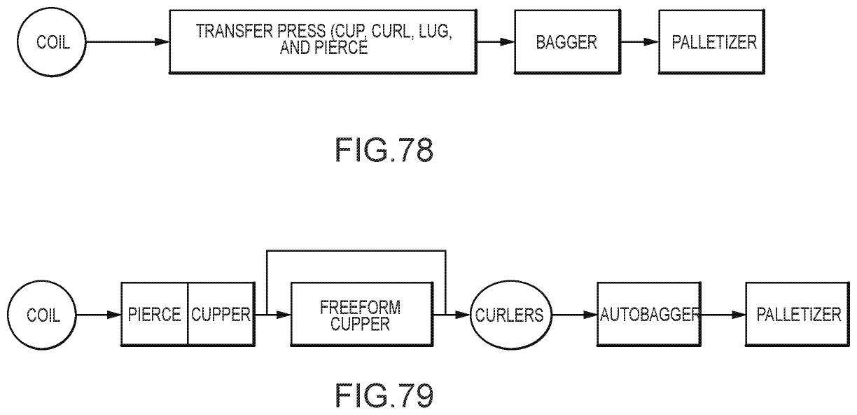

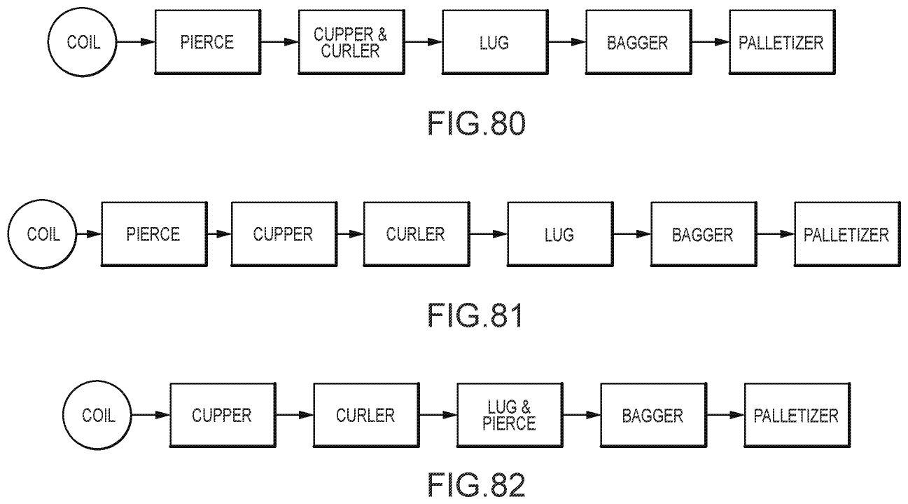

FIG. 5 is a bottom plan view of the lid 2. FIG. 6 is a cross-sectional front elevation view of the lid 2 taken at the line 6-6 in FIG. 4. FIG. 6 shows various dimensional measurements for the lid 2. The term “about” can mean a variation of +/−10% on a relative basis. In one embodiment, the outer diameter OD of the lid 2 is between about 3.6 inches and about 4.0 inches, or 3.6 inches, 3.7 inches, 3.8 inches, 3.9 inches, and 4.0 inches, or a range or value between two of these values. In a preferred embodiment, the outer diameter OD of the lid 2 is about 3.8 inches. In one embodiment, the inner diameter ID of the lid 2 is between about 3.4 inches and 3.8 inches, or 3.4 inches, 3.5 inches, 3.6 inches, 3.7 inches, and 3.8 inches, or a range or value between two of these values. In a preferred embodiment, the inner diameter ID of the lid 2 is 3.6 inches. In one embodiment, the diameter D2 of the raised rim 10 is between about 2.4 inches and about 2.8 inches, or 2.4 inches, 2.5 inches, 2.6 inches, 2.7 inches, and 2.8 inches, or a range or value between two of these values. In a preferred embodiment, the diameter D2 of the raised rim 10 is about 2.6 inches. In one embodiment, the diameter D3 of the countersink inner wall 26 is between about 3.3 inches and about 3.7 inches, or 3.3 inches, 3.4 inches, 3.5 inches, 3.6 inches, and 3.7 inches, or a range or value between two of these values. In a preferred embodiment, the diameter D3 of the countersink inner wall 26 is about 3.5 inches. In one embodiment, the height H1 of the lid 2 is between about 0.7 inch and about 1.1 inch, or 0.7 inch, 0.8 inch, 0.9 inch, 1.0 inch, and 1.1 inch, or a range or value between two of these values. In a preferred embodiment, the height H1 of the lid 2 is about 0.9 inch. In one embodiment, the height H2 of the curl 32 is between about 0.07 and 0.08 inch, or 0.07, 0.072 inch, 0.074 inch, 0.076 inch, 0.078 inch, and 0.08 inch, or a range or value between two of these values. In a preferred embodiment, the height H2 of the curl 32 is about 0.076 inch. In one embodiment, the height H4 of the countersink 28 to the top of the curl 32 is between about 0.3 inch and about 0.5 inch, or 0.3 inch, 0.35 inch, 0.4 inch, 0.45 inch, and 0.5 inch, or a range or value between two of these values. In a preferred embodiment, the height H4 of the countersink 28 to the top of the curl 32 is about 0.4 inch. In one embodiment, the height H5 of the recessed portion 24 to the top of the raised rim 10 is between about 0.2 inch and about 0.6 inch, or 0.2 inch, 0.3 inch, 0.4 inch, 0.5 inch, and 0.6 inch, or a range or value between two of these values. In a preferred embodiment, the height H5 of the recessed portion 24 to the top of the raised rim 10 is 0.4 inch. In one embodiment, the lid curl 32 radius of curvature R5 is between about 0.03 inch and 0.042 inch, or 0.03 inch, 0.033 inch, 0.036 inch, 0.038 inch, 0.04 inch, and 0.042 inch, or a range or value between two of these values. In a preferred embodiment, the lid curl 32 radius of curvature R5 is about 0.0380 inch. In one embodiment, the raised rim 10 radius of curvature R6 is between about 0.075 inch and about 0.125 inch, or 0.075 inch, 0.085 inch, 0.095 inch, 0.1 inch, 0.105 inch, 0.115 inch, and 0.125 inch, or a range or value between two of these values. In a preferred embodiment, the raised rim 10 radius of curvature R6 is 0.1 inch. In one embodiment, the raised rim lip contour 22 radius of curvature R7 is between about 0.2 inch and 0.6 inch, or 0.2 inch, 0.3 inch, 0.4 inch, 0.5 inch, and 0.6 inch, or a range or value between two of these values. In a preferred embodiment, the raised rim lip contour 22 radius of curvature R7 is about 0.4 inch. In one embodiment, the raised rim shoulder radius of curvature R8 is between about 0.1 inch and 0.3 inch, or 0.1 inch, 0.2 inch, and 0.3 inch, or a range or value between two of these values. In a preferred embodiment, the raised rim shoulder radius of curvature R8 is about 0.2 inch. In one embodiment, the recessed portion 24 of the center panel 4 has a radius of curvature R9 between about 4.0 inches and 5.0 inches, or 4.0 inches, 4.2 inches, 4.4 inches, 4.5 inches, 4.6 inches, 4.8 inches, and 5.0 inches or a range or value between two of these values. In a preferred embodiment, the recessed portion 24 of the center panel 4 has a radius of curvature R9 of about 4.5 inches.

However, the lids can be larger or smaller (e.g., in diameter) depending on the size of the cup in which the lid 2 is used and the size and shape of the dispensing orifice 6 can change depending on the desired final use and still be within the scope of the invention. Embodiments of the lid 2 with other dimensions are within the scope of the invention and this disclosure.

FIG. 7 is a perspective view of the metallic dispensing lid 2 of FIG. 1 interconnected to a cup 40. In the embodiment shown, the cup 40 is a tapered cup with multiple tapered portions formed by ribs 42. The cup 40 has a curl 44 at the top or upper end 46 of the cup, a closed bottom 48 opposite the upper end 46, and a body 50 having a sidewall 52 or sidewall portions therebetween. The sidewall 52 comprises a plurality of tapered portions 42 formed by ribs 42.

FIG. 8 is a front elevation view of the metallic dispensing lid 2 and cup 40, the right, left, and rear elevation views being substantially the same as the front elevation view. FIG. 9 is a top plan view of the metallic dispensing lid 2 and cup 40. FIG. 10 is a bottom plan view of the metallic dispensing lid 2 and cup 40. FIG. 11 is an exploded perspective view of the metallic dispensing lid 2 and cup 40 and shows the opening 54 at the cup upper end 46, the inner surface 56 of the sidewall 52, and the outer surface 58 of the side wall 52.

FIG. 12 is a top perspective view of a second embodiment of a metallic dispensing lid 2. This lid 2 is designed for cold beverages, specifically iced coffees and other iced beverages including soft drinks, lemonade, tea, etc., but can be used with warm drinks. The lid 2 includes a center panel 4 that may be substantially flat and substantially horizontal in some embodiments. In other embodiments, the center panel 4 may have a domed center portion 74 that functions as a drain back feature to move fluids back to the dispensing orifice 6. The domed portion 74 also adds rigidity to the lid 2, making the lid 2 stronger such that it can be made of thinner material. The diameter D6 of the domed portion 74 can be larger or smaller than shown without departing from the present invention. The domed portion 74 is formed by a small protrusion punch with a female portion on one side and a male portion (the protrusion punch) on the other side. The center panel 4 may include various other shapes to improve rigidity or customer-specific shapes, such as logos. Additionally, the upper surface 78 of the center panel 4 can be decorated with customer specific artwork and/or logos.

The center panel 4 comprises a dispensing orifice 6 for dispensing liquids therethrough. The center panel 4 also has a vent hole 8 in some embodiments to improve fluid flow through the dispensing orifice 6 and for ease of pouring liquid out of the dispensing orifice 6. The lid 2 has a curl 32 around an uppermost perimeter. The curl 32 is interconnected to a sidewall 84, which is interconnected to the center panel 4. The sidewall inner surface 70 and sidewall outer surface 72 are shown. It is desired that the height of the lid 2 (as measured from the top of the curl to the bottom of the center panel) be as small as possible to reduce the material needed and thus reduce the cost, but the lid height must be large enough to have enough sidewall 84 to engage the inner surface of the cup and keep the lid 2 secured on the cup.

FIG. 13 is a bottom perspective view of the metallic dispensing lid 2 and shows the bottom surface 76 of the center panel 4 and the bottom surface of the domed portion 74. FIG. 14 is a front elevation view of the metallic dispensing lid 2, the right, left, and rear elevation views being substantially the same as the front elevation view. In some embodiments the sidewall 84 is substantially vertical or angled slightly outward (i.e., at a slight angle relative to a vertical axis, meaning the top of the sidewall 84 proximate the curl 32 is slightly farther away from a center axis of the lid 2 than the bottom of the sidewall 84). In other embodiments, the sidewall comprises a substantially vertical portion 80 or a slightly outwardly angled linear portion and a curved portion 82. The substantially vertical portion 80 engages the inner surface of an upper portion of the cup to secure the lid 2 to the cup. In some embodiments, the outer diameter of the substantially vertical sidewall portion 80 is approximately the same as or slightly larger than the inner diameter of the upper portion of the cup such that the substantially vertical sidewall 80 provides spring pressure to secure the lid 2 to the cup. Specifically, when the user pushes the lid 2 down onto the cup, the sidewall 84 deforms (i.e., is pushed inward) and the sidewall 84 tries to push itself outward, which securely pushes the lid 2 against the cup.

FIG. 15 is a top plan view of the metallic dispensing lid 2. In some embodiments, the diameter D1 of the vent hole 8 is between about 0.1 inch and 0.15 inch, or 0.1 inch, 0.11 inch, 0.12 inch, 0.125 inch, 0.13 inch, 0.14 inch, and 0.15 inch, or a range or value between two of these values. In a preferred embodiment, the diameter D1 of the vent hole 8 is about 0.125 inch. In one embodiment, the length L1 in the radial direction of the dispensing orifice 6 is between about 0.5 inch and 1.0 inch, or 0.5 inch, 0.6 inch, 0.688 inch, 0.7 inch, 0.8 inch, 0.9 inch, and 1.0 inch, or a range or value between two of these values. In a preferred embodiment, the length L1 in the radial direction of the dispensing orifice 6 is about 0.688 inch. In one embodiment, the length L2 of the dispensing orifice 6 in the horizontal direction as shown in FIG. 15 is between about 0.4 inch and about 0.8 inch, or 0.4 inch, 0.5 inch, 0.6 inch, 0.641 inch, 0.7 inch, and 0.8 inch, or a range or value between two of these values. In a preferred embodiment, the length L2 of the dispensing orifice 6 in the horizontal direction as shown in FIG. 15 is about 0.641 inch.

FIG. 16 is a bottom plan view of the metallic dispensing lid 2. FIG. 17 is a cross-sectional front elevation view of the metallic dispensing lid 2 taken at the line 17-17 in FIG. 15. FIG. 17 shows various dimensional measurements for the lid 2. The term “about” can mean a variation of +/−10% on a relative basis. The retention area, i.e., the portion of the lid 2 that engages the inner surface of the cup and applies pressure to the inner diameter of the cup to securely hold the lid 2 onto the cup, is shown in FIG. 17. The retention area or retention height RH should be at least 0.05 inches, and preferably 0.1 inches or more, to ensure there is enough area to securely engage the cup. In some embodiments, the retention height RH is between about 0.1 inch and 0.3 inch, or about 0.1 inch, 0.117 inch, 0.15 inch, 0.195 inch, 0.2 inch, 0.25 inch, and 0.3 inch, or a range or value between two of these values. In a preferred embodiment, the retention height RH is about 0.1950 inch. In another preferred embodiment, the retention height RH is about 0.117 inch.

In one embodiment, the outer diameter OD of the lid 2 is between about 3.6 inches and about 4.4 inches, or 3.6 inches, 3.7 inches, 3.8 inches, 3.9 inches, 4.0 inches, 4.1 inches, 4.2 inches, 4.3 inches, and 4.4 inches, or a range or value between two of these values. In a preferred embodiment, the outer diameter OD of the lid 2 is about 4.0 inches. In one embodiment, the inner diameter ID of the lid 2 is between about 3.4 inches and 3.8 inches, or 3.4 inches, 3.5 inches, 3.6 inches, 3.7 inches, and 3.8 inches, or a range or value between two of these values. In a preferred embodiment, the inner diameter ID of the lid 2 is 3.6 inches. In one embodiment, the height H1 of the lid 2 is between about 0.4 inch and about 0.8 inch, or 0.4 inch, 0.5 inch, 0.6 inch, 0.7 inch, and 0.8 inch, or a range or value between two of these values. In a preferred embodiment, the height H1 of the lid 2 is about 0.6 inch. In one embodiment, the height H2 of the curl 32 is between about 0.1 and 0.2 inch, or 0.1 inch, 0.12 inch, 0.14 inch, 0.146 inch, 0.16 inch, 0.18 inch, and 0.2 inch, or a range or value between two of these values. In a preferred embodiment, the height H2 of the curl 32 is about 0.146 inch. In one embodiment, the height H6 of the domed portion 74 is between about 0.03 inch and about 0.07 inch, or 0.03 inch, 0.04 inch, 0.05 inch, 0.06 inch, and 0.07 inch, or a range or value between two of these values. In a preferred embodiment, the height H6 of the domed portion 74 is 0.05 inch. In some embodiments, the height H7 of the straight portion 80 of the sidewall 84 is between about 0.1 inch and 0.3 inch, or about 0.1 inch, 0.15 inch, 0.195 inch, 0.2 inch, 0.25 inch, and 0.3 inch, or a range or value between two of these values. In a preferred embodiment, the height H7 of the straight portion 80 of the sidewall 84 is about 0.1950 inch.

In some embodiments, the lid curl 32 has one consistent radius of curvature and in other embodiments, the lid curl 32 has two or more radii of curvature. In one embodiment, the lid curl 32 inner radius of curvature R5A is between about 0.04 inch and 0.09 inch, or 0.04 inch, 0.05 inch, 0.06 inch, 0.068 inch, 0.07 inch, 0.08 inch, and 0.09 inch, or a range or value between two of these values. In a preferred embodiment, the lid curl 32 inner radius of curvature R5A is about 0.0680 inch. In one embodiment, the lid curl 32 outer radius of curvature R5B is between about 0.05 inch and 0.09 inch, or 0.05 inch, 0.06 inch, 0.07 inch, 0.073 inch, 0.08 inch, and 0.09 inch, or a range or value between two of these values. In a preferred embodiment, the lid curl 32 outer radius of curvature R5B is about 0.0730 inch.

However, the lids can be larger or smaller (e.g., in diameter) depending on the size of the cup in which the lid is used and the size and shape of the dispensing orifice can change depending on the desired final use and still be within the scope of the invention. The dimensional data provided herein is provided as an example of one embodiment. Embodiments of the lid with other dimensions are within the scope of the invention and this disclosure.

FIG. 18 is a perspective view of the metallic dispensing lid 2 of FIG. 12 interconnected to a cup 40. In the embodiment shown, the cup 40 is a tapered cup with multiple tapered portions 42 formed by ribs 42. The cup 40 has a curl 44 at the top or upper end of the cup, a closed bottom 48 opposite the upper end, and a body 50 having a sidewall 52 or sidewall portions therebetween. The sidewall 52 comprises a plurality of tapered portions 42 formed by ribs 42.

FIG. 19 is a front elevation view of the metallic dispensing lid 2 and cup 40, the right, left, and rear elevation views being substantially the same as the front elevation view. The curl 32 of the lid 2 compared to the curl 44 of the cup 40 is clearly shown in FIG. 19. The lid's curl 32 is larger and has a larger outer diameter than the curl 44 of the cup 32, which makes it easier for the consumer to remove the lid 2 from the cup 40. However, in some embodiments, the diameter of lid's curl 32 (meaning the radius of curvature) may be smaller than the diameter of the cup's curl 44 (meaning the radius of curvature) if ease of manufacturing is more important than ease of removing the lid 2 from the cup 40. FIG. 20 is a top plan view of the metallic dispensing lid 2 and cup 40. FIG. 21 is a bottom plan view of the metallic dispensing lid 2 and cup 40. FIG. 22 is an exploded front view of the metallic dispensing lid 2 and cup 40 and shows the cup upper end 46 opposite the closed bottom 48 of the cup 40.

FIG. 23 is a top perspective view of a third embodiment of a metallic dispensing lid 2. This lid 2 is designed for cold beverages, specifically iced coffees and other iced beverages consumers can drink without a straw, but it can be used with warm drinks. The lid 2 includes a center panel 4 that may be substantially flat and substantially horizontal in some embodiments. In other embodiments, the center panel 4 may be curved or angled downward to form a domed shape 24. In the embodiment shown, the center panel 4 curves downward 24 to accommodate a user's nose. The center panel 4 may include various other shapes to improve rigidity or customer-specific shapes, such as logos. Additionally, the center panel 4 can be decorated with customer specific artwork and/or logos. The center panel 4 comprises a dispensing orifice 6 for dispensing liquids therethrough and, in some embodiments, a vent hole 8 to improve fluid flow through the dispensing orifice 6 and for ease of pouring liquid out of the dispensing orifice 6. Interconnected to the perimeter of the center panel 4 is an inner sidewall 100 that extends upwardly to a raised rim 10, which may be raised above the center panel 4 (measured from the top of the raised rim to the lowest point of the center panel) a height between about 0.3 inches and about 0.7 inches. In a preferred embodiment, the top of the raised rim 10 is raised above the lowest point of the center panel a height of about 0.5 inches.

The raised rim extends downwardly and away from the center panel forming a substantially vertical outer sidewall 102, which interconnects to a horizontal portion or flange 104. The raised rim 10, the inner sidewall 100, the substantially vertical outer sidewall 102, and the horizontal portion 104 are designed to accommodate a user's lips and provide a comfortable drinking experience. The raised rim 10 can also aid in residual liquid draining back into the dispensing orifice 6. The horizontal portion 104 curves downward at an outer perimeter forming a lower sidewall 110 (FIG. 28), which interconnects to the curl 32. The curl 32 has a larger outer diameter than the lower sidewall 110 and outer perimeter of the horizontal portion 104. The curl 32 has a radius of curvature between about 0.03 inches and about 0.07 inches, which is selected for ease of manufacturing. Alternatively, the curl 32 could have a larger radius of curvature such that the lid 2 is easier to remove from the cup, if functionality is more important than ease of manufacturing. The curl 32 hides the cut edge of the material, adds rigidity to the lid 2, and creates a surface for the consumer to pull against when removing the lid 2 from the cup.

FIG. 24 is a bottom perspective view of the metallic dispensing lid 2 and the outer sidewall 102 of the lid 2 can be seen in this view, along with both the inner surface 112 and outer surface 114 of the outer sidewall 102. FIG. 25 is a front elevation view of the metallic dispensing lid, the right, left, and rear elevation views being substantially the same as the front elevation view. The vertical sidewall 102 of the lid 2, which is connected to the horizontal flange portion 104 is clearly shown in this view.

FIG. 26 is a top plan view of the metallic dispensing lid 2. In some embodiments, the diameter D1 of the vent hole 8 is between about 0.04 inch and 0.11 inch, or 0.04 inch, 0.05 inch, 0.06 inch, 0.07 inch, 0.08 inch, 0.09 inch, 0.1 inch, and 0.11 inch, or a range or value between two of these values. In a preferred embodiment, the diameter D1 of the vent hole 8 is about 0.06 inch. In one embodiment, the length L1 in the radial direction of the dispensing orifice 6 is between about 0.5 inch and 1.5 inch, or 0.5 inch, 0.7 inch, 0.9 inch, 1.0 inch, 1.1 inch, 1.3 inch, and 1.5 inch, or a range or value between two of these values. In a preferred embodiment, the length L1 in the radial direction of the dispensing orifice 6 is about 0.9 inch. In one embodiment, the length L2 of the dispensing orifice 6 in the horizontal direction as shown in FIG. 26 is between about 0.5 inch and about 1.1 inch, or 0.5 inch, 0.6 inch, 0.7 inch, 0.8 inch, 0.9 inch, 1.0 inch, and 1.1 inch, or a range or value between two of these values. In a preferred embodiment, the length L2 of the dispensing orifice 6 in the horizontal direction as shown in FIG. 26 is about 0.8 inch.

FIG. 27 is a bottom plan view of the metallic dispensing lid 2. FIG. 28 is a cross-sectional front elevation view of the metallic dispensing lid 2 taken at the line 28-28 in FIG. 26. Here, the contour of the lid 2 is shown and dimensional data is provided. In the embodiment shown, the inner sidewall 100 has a substantially vertical portion 106 proximate the top of the raised rim 10 and a curved portion 108 extending downward from the substantially vertical portion 106 and interconnecting to the center panel 4. The inner surface of the lower sidewall 110 engages the curl of the cup to secure the lid 2 to the cup. In some embodiments, the inner diameter ID of the lower sidewall is the same as or slightly smaller than the outer diameter of the curl of the cup such that it can securely engage the curl of the cup.

FIG. 28 shows various dimensional measurements for the lid 2. The term “about” can mean a variation of +/−10% on a relative basis. In one embodiment, the outer diameter OD of the lid 2 is between about 3.7 inches and about 4.4 inches, or 3.7 inches, 3.8 inches, 3.9 inches, 4.0 inches, 4.1 inches, 4.2 inches, 4.3 inches, and 4.4 inches, or a range or value between two of these values. In a preferred embodiment, the outer diameter OD of the lid 2 is about 4.1 inches. In one embodiment, the inner diameter ID of the lid 2 is between about 3.6 inches and 4.2 inches, or 3.6 inches, 3.7 inches, 3.8 inches, 3.9 inches, 4.0 inches, 4.1 inches, and 4.2 inches, or a range or value between two of these values. In a preferred embodiment, the inner diameter ID of the lid 2 is 3.9 inches. In one embodiment, the diameter D4 of the raised rim 10 outer sidewall 102 is between about 3.0 inches and about 4.0 inches, or 3.0 inches, 3.2 inches, 3.4 inches, 3.5 inches, 3.6 inches, 3.8 inches, and 4.0 inches, or a range or value between two of these values. In a preferred embodiment, the diameter D4 of the raised rim 10 outer sidewall 102 is about 3.5 inches. In one embodiment, the diameter D7 of the raised rim 10 inner sidewall 100 is between about 3.0 inches and about 3.5 inches, or 3.0 inches, 3.1 inches, 3.2 inches, 3.3 inches, 3.4 inches, and 3.5 inches, or a range or value between two of these values. In a preferred embodiment, the diameter D7 of the raised rim 10 inner sidewall 100 is about 3.2 inches.

In one embodiment, the height H1 of the lid 2 is between about 0.5 inch and about 1.0 inch, or 0.5 inch, 0.6 inch, 0.7 inch, 0.8 inch, 0.9 inch, and 1.0 inch, or a range or value between two of these values. In a preferred embodiment, the height H1 of the lid 2 is about 0.7 inch. In one embodiment, the height H2 of the curl 32 is between about 0.05 inch and 0.2 inch, or 0.05 inch, 0.075 inch, 0.1 inch, 0.125 inch, 0.15 inch, 0.175 inch, and 0.2 inch, or a range or value between two of these values. In a preferred embodiment, the height H2 of the curl 32 is about 0.1 inch or 0.125 inch. In one embodiment, the height H8 of the flange 104 to the top of the raised rim 10 is between about 0.3 inch and about 0.7 inch, or 0.3 inch, 0.4 inch, 0.5 inch, 0.6 inch, and 0.7 inch, or a range or value between two of these values. In a preferred embodiment, the height H8 of the flange 104 to the top of the raised rim 10 is about 0.5 inch.

In some embodiments, the center panel 4 is curved downwardly and has two radii of curvature between the vertical portion 106 of the inner sidewall 100. In some embodiments, the radius of curvature R9 of the lower portion of the center panel 4 is between about 5.0 inches and 6.0 inches, or 5.0 inches, 5.2 inches, 5.4 inches, 5.6 inches, 5.7 inches, 5.8 inches, and 6.0 inches or a range or value between two of these values. In a preferred embodiment, the radius of curvature R9 of the lower portion of the center panel 4 is about 5.7 inches. In some embodiments, the radius of curvature R10 of the corner of the center panel 4, i.e., the portion just below the vertical portion 106, is between about 0.3 inch and 0.6 inch, or 0.3 inch, 0.35 inch, 0.4 inch, 0.45 inch, 0.5 inch, 0.55 inch, and 0.6 inch, or a range or value between two of these values. In a preferred embodiment, the radius of curvature R10 of the corner of the center panel 4 is about 0.4 inch.

However, the lids can be larger or smaller (e.g., in diameter) depending on the size of the cup in which the lid is used and the size and shape of the dispensing orifice can change depending on the desired final use and still be within the scope of the invention. The dimensional data provided here is provided as an example of one embodiment. Embodiments of the lid with other dimensions are within the scope of the invention and this disclosure.

FIG. 29 is a perspective view of the metallic dispensing lid 2 of FIG. 23 interconnected to a cup 40. In the embodiment shown, the cup 40 is a tapered cup with multiple tapered portions 42 formed by ribs 42. The cup 40 has a curl 44 at the top or upper end 46 of the cup, a closed bottom 48 opposite the upper end 46, and a body 50 having a sidewall 52 or sidewall portions therebetween. The sidewall 52 comprises a plurality of tapered portions 42 formed by ribs 42.

FIG. 30 is a front elevation view of the metallic dispensing lid 2 and cup 40, the right, left, and rear elevation views being substantially the same as the front elevation view. FIG. 31 is a top plan view of the metallic dispensing lid 2 and cup 40. FIG. 32 is a bottom plan view of the metallic dispensing lid 2 and cup 40. FIG. 33 is an exploded front view of the metallic dispensing lid 2 and cup 40.

The lid 2 of FIGS. 34-44 is the same as the lid 2 of FIGS. 23-33 except that the lid 2 of FIGS. 34-44 includes lug features 120 (also called snap-on features) to aid in securing the lid 2 to the cup. Specifically, the lug features 120 snap onto and engage the curl of the cup. Thus, any redundant description of FIGS. 23-33 will not be presented here, and the description of FIGS. 23-33 is incorporated here by this reference.

FIG. 34 is a top perspective view of a fourth embodiment of a metallic dispensing lid 2. The lid 2 can have two or more lug features 120 in some embodiments. In a preferred embodiment, the lid 2 comprises three or more lug features 120. The lid 1 shown comprises four lug features 120. More than four lugs 120 are possible in other embodiments. Additionally, the lugs 120 can be longer or shorter (arc length) than shown in the drawings.

FIG. 35 is a bottom perspective view of the metallic dispensing lid 2. FIG. 36 is a front elevation view of the metallic dispensing lid 2, the right, left, and rear elevation views being substantially the same as the front elevation view.

FIG. 37 is a top plan view of the metallic dispensing lid. The dimensional data discussed in connection with FIG. 26 apply to the lid 2 shown in FIG. 37. In some embodiments, the diameter D1 of the vent hole 8 is between about 0.04 inch and 0.11 inch, or 0.04 inch, 0.05 inch, 0.06 inch, 0.07 inch, 0.08 inch, 0.09 inch, 0.1 inch, and 0.11 inch, or a range or value between two of these values. In a preferred embodiment, the diameter D1 of the vent hole 8 is about 0.06 inch. In one embodiment, the length L1 in the radial direction of the dispensing orifice 6 is between about 0.5 inch and 1.5 inch, or 0.5 inch, 0.7 inch, 0.9 inch, 1.0 inch, 1.1 inch, 1.3 inch, and 1.5 inch, or a range or value between two of these values. In a preferred embodiment, the length L1 in the radial direction of the dispensing orifice 6 is about 0.9 inch. In one embodiment, the length L2 of the dispensing orifice 6 in the horizontal direction as shown in FIG. 37 is between about 0.5 inch and about 1.1 inch, or 0.5 inch, 0.6 inch, 0.7 inch, 0.8 inch, 0.9 inch, 1.0 inch, and 1.1 inch, or a range or value between two of these values. In a preferred embodiment, the length L2 of the dispensing orifice 6 in the horizontal direction as shown in FIG. 37 is about 0.8 inch.

FIG. 38 is a bottom plan view of the metallic dispensing lid. FIG. 39 is a cross-sectional front elevation view of the metallic dispensing lid taken at the line 39-39 in FIG. 37. This cross-section is taken through the lug features. A cross-sectional elevation view taken through a portion of the lid 2 without the lug features is shown in FIG. 28. As shown in FIG. 28, the horizontal portion 104 of the lid 2 curves downward at an outer perimeter forming a lower sidewall 110, which interconnects to the curl 32. The curl 32 has a larger outer diameter than the outer diameter of the lower sidewall 110 and outer perimeter of the horizontal portion 104.

FIGS. 39, 39A, and 39B show various dimensional measurements for the lid 2. The dimensions provided above in connection with FIG. 28 apply to the present embodiment of the lid 2. The term “about” can mean a variation of +/−10% on a relative basis. In one embodiment, the outer diameter OD of the lid 2 is between about 3.7 inches and about 4.4 inches, or 3.7 inches, 3.8 inches, 3.9 inches, 4.0 inches, 4.1 inches, 4.2 inches, 4.3 inches, and 4.4 inches, or a range or value between two of these values. In a preferred embodiment, the outer diameter OD of the lid 2 is about 4.1 inches. In one embodiment, the inner diameter ID of the lid 2 is between about 3.6 inches and 4.2 inches, or 3.6 inches, 3.7 inches, 3.8 inches, 3.9 inches, 4.0 inches, 4.1 inches, and 4.2 inches, or a range or value between two of these values. In a preferred embodiment, the inner diameter ID of the lid 2 is 3.9 inches. In one embodiment, the diameter D4 of the raised rim 10 outer sidewall 102 is between about 3.0 inches and about 4.0 inches, or 3.0 inches, 3.2 inches, 3.4 inches, 3.5 inches, 3.6 inches, 3.8 inches, and 4.0 inches, or a range or value between two of these values. In a preferred embodiment, the diameter D4 of the raised rim 10 outer sidewall 102 is about 3.5 inches. In one embodiment, the diameter D7 of the raised rim 10 inner sidewall 100 is between about 3.0 inches and about 3.5 inches, or 3.0 inches, 3.1 inches, 3.2 inches, 3.3 inches, 3.4 inches, and 3.5 inches, or a range or value between two of these values. In a preferred embodiment, the diameter D7 of the raised rim 10 inner sidewall 100 is about 3.2 inches.

In one embodiment, the height H1 of the lid 2 is between about 0.5 inch and about 1.0 inch, or 0.5 inch, 0.6 inch, 0.7 inch, 0.8 inch, 0.9 inch, and 1.0 inch, or a range or value between two of these values. In a preferred embodiment, the height H1 of the lid 2 is about 0.7 inch. In one embodiment, the height H8 of the flange 104 to the top of the raised rim 10 is between about 0.3 inch and about 0.7 inch, or 0.3 inch, 0.4 inch, 0.5 inch, 0.6 inch, and 0.7 inch, or a range or value between two of these values. In a preferred embodiment, the height H8 of the flange 104 to the top of the raised rim 10 is about 0.5 inch. In some embodiments, the center panel 4 is curved downwardly and has two radii of curvature between the vertical portion 106 of the inner sidewall 100. In some embodiments, the radius of curvature R9 of the lower portion of the center panel 4 is between about 5.0 inches and 6.0 inches, or 5.0 inches, 5.2 inches, 5.4 inches, 5.6 inches, 5.7 inches, 5.8 inches, and 6.0 inches or a range or value between two of these values. In a preferred embodiment, the radius of curvature R9 of the lower portion of the center panel 4 is about 5.7 inches. In some embodiments, the radius of curvature R10 of the corner of the center panel 4, i.e., the portion just below the vertical portion 106, is between about 0.3 inch and 0.6 inch, or 0.3 inch, 0.35 inch, 0.4 inch, 0.45 inch, 0.5 inch, 0.55 inch, and 0.6 inch, or a range or value between two of these values. In a preferred embodiment, the radius of curvature R10 of the corner of the center panel 4 is about 0.4 inch.

FIG. 39A is an enlarged view of the lug feature 120 shown in cross-section without a cup. The lug feature 120 comprises folded metal that protrudes inwardly as compared to the lid curl 32 and the lower sidewall (110 in FIG. 28). Thus, the metal that would form the curl 32 is cut (to separate it from the rest of the curl 32), bent upward, and bent inward to create the lug feature 120. Specifically, the lug feature 120 comprises a portion extending inward and at a downward angle from the lower sidewall, which is interconnected to an inner curved portion 130 interconnected to a substantially flat or linear portion 128 extending outward and upward at an angle, which is interconnected to an upper curved portion 126 that curves inward to hide the cut end 132. The lid curl 32 can also be seen in this view because it is positioned behind the lug feature 120. However, the shape, size, and position of the curl 32 is somewhat deceiving in FIGS. 39A-B because the curl 32 shown is actually a distance behind and to the left of the lug feature 120, since the lid 2 is circular. Thus, the outer diameter of the lug feature 120 is actually smaller, albeit only slightly, than the outer diameter OD of the curl 32. This is more easily seen in FIGS. 34-38. The dashed lines in FIG. 39A are phantom lines showing the portion of the curl 32 and lug feature 120 behind the cut line.

FIG. 39B is the same enlarged view of the lug feature as FIG. 39A but also shows a cup 40 attached to the lid 2. In use, the lug features 120 snap onto the curl 44 of the cup via the spring effect or another biasing effect. As the user pushes the lid 2 down on the cup 40, the lug feature 120 is bent outward by the cup's curl 44 and the lug feature 120 springs back inward (toward the cup 40 and toward the lid vertical axis or centerline) and around the curl 44 of the cup 40 to hold the lid 2 on the cup 40 once the cup curl 44 is fully positioned within the lid 2. It is the inward extending portion of the lug feature 120 that engages a lower portion of the cup's curl 44 to hold the lid 2 onto the cup 40.

In one embodiment, the height H2 of the curl 32 is between about 0.05 and 0.2 inch, or 0.05, 0.075 inch, 0.1 inch, 0.125 inch, 0.15 inch, 0.175 inch, and 0.2 inch, or a range or value between two of these values. In a preferred embodiment, the height H2 of the curl 32 is about 0.1 inch or 0.125 inch. In one embodiment, the height H3 from the bottom of the lid curl 32 to top of shoulder 126 or flange 104 is between about 0.1 inch and 0.4 inch, or 0.1 inch, 0.2 inch, 0.3 inch, and 0.4 inch, or a range or value between two of these values. In a preferred embodiment, the height H3 from the bottom of the lid curl 32 to top of shoulder 126 or flange 104 is about 0.2 inch. In one embodiment, the height H9 of the lug feature 120 is between about 0.05 inch and 0.15 inch, or 0.05 inch, 0.075 inch, 0.827 inch, 0.1 inch, 0.125 inch, and 0.15 inch, or a range or value between two of these values. In a preferred embodiment, the height H9 of the lug feature 120 is about 0.0827 inch.

In one embodiment, the cup curl 44 radius of curvature R1 is between about 0.04 inch and about 0.08 inch, or 0.04 inch, 0.05 inch, 0.06 inch, 0.0625 inch, 0.07 inch, and 0.08 inch, or a range or value between two of these values. In a preferred embodiment, the cup curl 44 radius of curvature R1 is 0.0625 inch. In one embodiment, the rounded corner 124 radius of curvature R2 is between about 0.04 inch and about 0.08 inch, or 0.04 inch, 0.05 inch, 0.06 inch, 0.07 inch, and 0.08 inch, or a range or value between two of these values. In a preferred embodiment, the rounded corner 124 radius of curvature R2 is 0.06 inch. In one embodiment, the radius of curvature R3 of the inner curved portion 130 of the lug feature 120 is between about 0.015 inch and 0.045 inch, or 0.015 inch, 0.02 inch, 0.026 inch, 0.03 inch, 0.035 inch, 0.04 inch, and 0.045 inch, or a range or value between two of these values. In a preferred embodiment, the radius of curvature R3 of the inner curved portion 130 of the lug feature 120 is about 0.026 inch or 0.03 inch. In one embodiment, the radius of curvature R4 of the upper/outer curved portion 126 of the lug feature 120 is between about 0.025 inch and 0.06 inch, or 0.025 inch, 0.03 inch, 0.035 inch, 0.04 inch, 0.0415 inch, 0.045 inch, 0.05 inch, 0.055 inch, and 0.06 inch, or a range or value between two of these values. In a preferred embodiment, the radius of curvature R4 of the upper/outer curved portion 126 of the lug feature 120 is about 0.0415 inch. In one embodiment, the lid curl 32 radius of curvature R5 is between about 0.03 inch and 0.07 inch, or 0.03 inch, 0.04 inch, 0.0415 inch, 0.05 inch, 0.06 inch, and 0.07 inch, or a range or value between two of these values. In a preferred embodiment, the lid curl 32 radius of curvature R5 is about 0.0415 inch.

However, the lids can be larger or smaller (e.g., in diameter) depending on the size of the cup in which the lid is used and the size and shape of the dispensing orifice can change depending on the desired final use and still be within the scope of the invention. The dimensional data provided here is provided as an example of one embodiment. Embodiments of the lid with other dimensions are within the scope of the invention and this disclosure.

FIG. 39C is a cross-sectional view of a portion of the lid 2 interconnected to the upper end of a cup 40. FIG. 39C shows an alternative embodiment where a dimple feature 122 is used instead of the lug feature. A dimple or protuberance 122 is formed on an inner surface of the lid 2, for example the inner surface of the outer sidewall 110, such that the dimple feature 122 interacts with the curl 44 of the cup 40. Similar to the lug feature, the curl 32 and the outer sidewall 110 of the lid 2 move away from the lid centerline as the cup curl 44 is inserted into the lid 2. Once the curl 44 of the cup 40 is in position, the lid curl 32 and outer sidewall 110 snap back into their original positions. The dimple feature 122 extends under the cup curl 44 and holds the cup curl 44 within the receiving portion of the lid 2. The dimple feature 122 may extend around the entire circumference of the lid 2 or it may extend only a certain arc length, for example 5° to 25°, around the lid 2. If the dimple feature 122 only extends a certain arc length around the lid 2 and not along the entire circumference, then multiple dimple features 122 may be used, similar to the lug features. For example, the lid 2 could have two dimple features 122, three dimple features 122, four dimple features 122, or five or more dimple features 122. In some embodiments, the dimple feature 122 is embossed into the lid 2 from the outside, pressed into the lid 2, or otherwise formed in the lid 2. In some embodiments, the dimple feature 122 has a circular, spherical, semi-circular, or semi-spherical shape. In other embodiments, the dimple feature 122 has an extended ovular shape or a semi-extended-ovular shape, meaning it is shaped like a wide circle or half of a wide circle. In embodiments with one or more dimple features 122, the lid curl 32 is not interrupted or disrupted like it is with embodiments having one or more lug features.

FIG. 40 is a perspective view of the metallic dispensing lid 2 with lug features 120 interconnected to a cup 40. In the embodiment shown, the cup 40 is a tapered cup with multiple tapered portions 42 formed by ribs 42. The cup 40 has a curl 44 at the top or upper end 46 of the cup 40, a closed bottom 48 opposite the upper end 46, and a body 50 having a sidewall 52 or sidewall portions therebetween. The sidewall 52 comprises a plurality of tapered portions 42 formed by ribs 42.

FIG. 41 is a front elevation view of the metallic dispensing lid 2 and cup 40, the right, left, and rear elevation views being substantially the same as the front elevation view. FIG. 42 is a top plan view of the metallic dispensing lid 2 and cup 40. FIG. 43 is a bottom plan view of the metallic dispensing lid 2 and cup 40. FIG. 44 is an exploded front view of the metallic dispensing lid 2 and cup 40.

FIG. 45 is a top perspective view of a fifth embodiment of a metallic dispensing lid 2. The lid 2 of FIGS. 45-55 is the same as the lid 2 of FIGS. 34-44 except that the lid 2 of FIGS. 45-55 includes different lug features 120 (also called snap-on features) than the lug features 120 of the lid 2 of FIGS. 34-44. Specifically, the lug features 120 in the present embodiment includes a transitional portion 134 on either side of the lug feature 120. The lug features 120 aid in securing the lid 2 to the cup. Specifically, the lug features 120 snap onto and engage the curl of the lid. Thus, any redundant description of FIGS. 23-44 will not be presented here, and the description of FIGS. 23-44 is incorporated here by this reference. The lid 2 can have two or more lug features 120 in some embodiments. In a preferred embodiment, the lid 2 comprises three or more lug features 120. The lid 2 shown comprises four lug features 120. More than four lugs 120 are possible in other embodiments. Additionally, the lugs 120 can be longer or shorter (arc length) than shown in the drawings.

FIG. 46 is a bottom perspective view of the metallic dispensing lid 2. FIG. 47 is a front elevation view of the metallic dispensing lid 2, the right, left, and rear elevation views being substantially the same as the front elevation view. FIG. 48 is a top plan view of the metallic dispensing lid 2. The dimensional data discussed in connection with FIGS. 26 and 37 apply to the lid 2 shown in FIG. 48. In some embodiments, the diameter D1 of the vent hole 8 is between about 0.04 inch and 0.11 inch, or 0.04 inch, 0.05 inch, 0.06 inch, 0.07 inch, 0.08 inch, 0.09 inch, 0.1 inch, and 0.11 inch, or a range or value between two of these values. In a preferred embodiment, the diameter D1 of the vent hole 8 is about 0.06 inch. In one embodiment, the length L1 in the radial direction of the dispensing orifice 6 is between about 0.5 inch and 1.5 inch, or 0.5 inch, 0.7 inch, 0.9 inch, 1.0 inch, 1.1 inch, 1.3 inch, and 1.5 inch, or a range or value between two of these values. In a preferred embodiment, the length L1 in the radial direction of the dispensing orifice 6 is about 0.9 inch. In one embodiment, the length L2 of the dispensing orifice 6 in the horizontal direction as shown in FIG. 48 is between about 0.5 inch and about 1.1 inch, or 0.5 inch, 0.6 inch, 0.7 inch, 0.8 inch, 0.9 inch, 1.0 inch, and 1.1 inch, or a range or value between two of these values. In a preferred embodiment, the length L2 of the dispensing orifice 6 in the horizontal direction as shown in FIG. 48 is about 0.8 inch. FIG. 49 is a bottom plan view of the metallic dispensing lid.

FIG. 50 is a cross-sectional front elevation view of the metallic dispensing lid 2 taken at the line 50-50 in FIG. 48. This cross-section is taken through the lug features 120 and an enlarged view of the lug feature 120 cross section is shown in FIG. 50A. A cross-sectional elevation view taken through a portion of the lid 2 without the lug features is shown in FIG. 50B, i.e., taken at the line B-B in FIG. 48. As shown in FIG. 50B, the horizontal portion 104 of the lid 2 curves downward at an outer perimeter forming a lower sidewall 110, which interconnects to the curl 32.

FIGS. 50, 50A, and 50B show various dimensional measurements for the lid 2. The dimensions provided above in connection with FIGS. 28, 39, 39A, and 39B apply to the present embodiment of the lid 2. The term “about” can mean a variation of +/−10% on a relative basis. In one embodiment, the outer diameter OD of the lid 2 is between about 3.7 inches and about 4.4 inches, or 3.7 inches, 3.8 inches, 3.9 inches, 4.0 inches, 4.1 inches, 4.2 inches, 4.3 inches, and 4.4 inches, or a range or value between two of these values. In a preferred embodiment, the outer diameter OD of the lid 2 is about 4.1 inches. In one embodiment, the inner diameter ID of the lid 2 is between about 3.6 inches and 4.2 inches, or 3.6 inches, 3.7 inches, 3.8 inches, 3.9 inches, 4.0 inches, 4.1 inches, and 4.2 inches, or a range or value between two of these values. In a preferred embodiment, the inner diameter ID of the lid 2 is 3.9 inches. In one embodiment, the diameter D4 of the raised rim 10 outer sidewall 102 is between about 3.0 inches and about 4.0 inches, or 3.0 inches, 3.2 inches, 3.4 inches, 3.5 inches, 3.6 inches, 3.8 inches, and 4.0 inches, or a range or value between two of these values. In a preferred embodiment, the diameter D4 of the raised rim 10 outer sidewall 102 is about 3.5 inches. In one embodiment, the diameter D7 of the raised rim 10 inner sidewall 100 is between about 3.0 inches and about 3.5 inches, or 3.0 inches, 3.1 inches, 3.2 inches, 3.3 inches, 3.4 inches, and 3.5 inches, or a range or value between two of these values. In a preferred embodiment, the diameter D7 of the raised rim 10 inner sidewall 100 is about 3.2 inches.

In one embodiment, the height H1 of the lid 2 is between about 0.5 inch and about 1.0 inch, or 0.5 inch, 0.6 inch, 0.7 inch, 0.8 inch, 0.9 inch, and 1.0 inch, or a range or value between two of these values. In a preferred embodiment, the height H1 of the lid 2 is about 0.7 inch. In one embodiment, the height H8 of the flange 104 to the top of the raised rim 10 is between about 0.3 inch and about 0.7 inch, or 0.3 inch, 0.4 inch, 0.5 inch, 0.6 inch, and 0.7 inch, or a range or value between two of these values. In a preferred embodiment, the height H8 of the flange 104 to the top of the raised rim 10 is about 0.5 inch. In some embodiments, the center panel 4 is curved downwardly and has two radii of curvature between the vertical portion 106 of the inner sidewall 100. In some embodiments, the radius of curvature R9 of the lower portion of the center panel 4 is between about 5.0 inches and 6.0 inches, or 5.0 inches, 5.2 inches, 5.4 inches, 5.6 inches, 5.7 inches, 5.8 inches, and 6.0 inches or a range or value between two of these values. In a preferred embodiment, the radius of curvature R9 of the lower portion of the center panel 4 is about 5.7 inches. In some embodiments, the radius of curvature R10 of the corner of the center panel 4, i.e., the portion just below the vertical portion 106, is between about 0.3 inch and 0.6 inch, or 0.3 inch, 0.35 inch, 0.4 inch, 0.45 inch, 0.5 inch, 0.55 inch, and 0.6 inch, or a range or value between two of these values. In a preferred embodiment, the radius of curvature R10 of the corner of the center panel 4 is about 0.4 inch.

FIG. 50A is an enlarged view of the lug feature 120 shown in cross-section with a cup 40. The lug feature 120 comprises folded metal that protrudes inwardly as compared to the lid curl (32 in FIG. 50B) and the lower sidewall (110 in FIG. 50B). Thus, the metal that would form the curl 32 is bent or squished forming a transitional portion 134, bent upward, and bent inward to create the lug feature 120. Specifically, the lug feature 120 comprises a portion extending inward and at a downward angle from the lower sidewall 110, which is interconnected to an inner curved portion 130 interconnected to a substantially flat or linear portion 128 extending outward and upward at an angle, which is interconnected to an upper/outer curved portion 126 that curves inward to hide the cut end 132. In use, the lug features 120 snap onto the curl 44 of the cup 40 via the spring effect or another biasing effect. As the user pushes the lid 2 down on the cup 40, the lug feature 120 is bent outward by the cup's curl 44 and the lug feature 120 springs back inward (toward the cup 40 and toward the lid 2 center axis or centerline) and around the curl 44 of the cup 40 to hold the lid 2 on the cup 40 once the cup curl 44 is fully positioned within the lid 2. It is the inward extending portion of the lug feature 120 that engages a lower portion of the cup's curl 44 to hold the lid 2 onto the cup 40.

In one embodiment, the height H9 of the lug feature 120 is between about 0.05 inch and 0.15 inch, or 0.05 inch, 0.075 inch, 0.827 inch, 0.1 inch, 0.125 inch, and 0.15 inch, or a range or value between two of these values. In a preferred embodiment, the height H9 of the lug feature 120 is about 0.0827 inch.

In one embodiment, the cup curl 44 radius of curvature R1 is between about 0.04 inch and about 0.08 inch, or 0.04 inch, 0.05 inch, 0.06 inch, 0.0625 inch, 0.07 inch, and 0.08 inch, or a range or value between two of these values. In a preferred embodiment, the cup curl 44 radius of curvature R1 is 0.0625 inch. In one embodiment, the rounded corner 124 radius of curvature R2 is between about 0.04 inch and about 0.08 inch, or 0.04 inch, 0.05 inch, 0.06 inch, 0.07 inch, and 0.08 inch, or a range or value between two of these values. In a preferred embodiment, the rounded corner 124 radius of curvature R2 is 0.06 inch. In one embodiment, the radius of curvature R3 of the inner curved portion 130 of the lug feature 120 is between about 0.015 inch and 0.045 inch, or 0.015 inch, 0.02 inch, 0.026 inch, 0.03 inch, 0.035 inch, 0.04 inch, and 0.045 inch, or a range or value between two of these values. In a preferred embodiment, the radius of curvature R3 of the inner curved portion 130 of the lug feature 120 is about 0.026 inch or 0.03 inch. In one embodiment, the radius of curvature R4 of the upper/outer curved portion 126 of the lug feature 120 is between about 0.025 inch and 0.06 inch, or 0.025 inch, 0.03 inch, 0.035 inch, 0.04 inch, 0.0415 inch, 0.045 inch, 0.05 inch, 0.055 inch, and 0.06 inch, or a range or value between two of these values. In a preferred embodiment, the radius of curvature R4 of the upper/outer curved portion 126 of the lug feature 120 is about 0.0415 inch.

In one embodiment, the height H2 of the curl 32 is between about 0.05 and 0.2 inch, or 0.05, 0.075 inch, 0.1 inch, 0.125 inch, 0.15 inch, 0.175 inch, and 0.2 inch, or a range or value between two of these values. In a preferred embodiment, the height H2 of the curl 32 is about 0.1 inch or 0.125 inch. In one embodiment, the lid curl 32 radius of curvature R5 is between about 0.03 inch and 0.07 inch, or 0.03 inch, 0.04 inch, 0.0415 inch, 0.05 inch, 0.06 inch, and 0.07 inch, or a range or value between two of these values. In a preferred embodiment, the lid curl 32 radius of curvature R5 is about 0.0415 inch.

However, the lids can be larger or smaller (e.g., in diameter) depending on the size of the cup in which the lid is used and the size and shape of the dispensing orifice can change depending on the desired final use and still be within the scope of the invention. The dimensional data provided here is provided as an example of one embodiment. Embodiments of the lid with other dimensions are within the scope of the invention and this disclosure.

FIG. 51 is a perspective view of the metallic dispensing lid 2 interconnected to a cup 40. In the embodiment shown, the cup 40 is a tapered cup with multiple tapered portions 42 formed by ribs 42. The cup 40 has a curl 44 at the top or upper end of the cup 40, a closed bottom 48 opposite the upper end 46, and a body 50 having a sidewall 52 or sidewall portions therebetween. The sidewall 50 comprises a plurality of tapered portions 42 formed by ribs 42.

FIG. 52 is a front elevation view of the metallic dispensing lid 2 and cup 40, the right, left, and rear elevation views being substantially the same as the front elevation view. FIG. 53 is a top plan view of the metallic dispensing lid 2 and cup 40. FIG. 54 is a bottom plan view of the metallic dispensing lid 2 and cup 54. FIG. 55 is an exploded front view of the metallic dispensing lid 2 and cup 54.

FIG. 56 is a top perspective view of a sixth embodiment of a metallic dispensing lid 2. This lid 2 is designed for cold beverages, for example, beverages consumers can drink without a straw, but it can be used with warm drinks. The lid 2 includes a center panel 4 that may be substantially flat and substantially horizontal in some embodiments. In other embodiments, the center panel 4 may be curved or angled downward to form a domed shape. The center panel 4 may include various other shapes to improve rigidity or customer-specific shapes, such as logos. Additionally, the center panel 4 can be decorated with customer specific artwork and/or logos. The center panel 4 comprises a dispensing orifice 6 for dispensing liquids therethrough and, in some embodiments, a vent hole 8 to improve fluid flow through the dispensing orifice 6 and for ease of pouring liquid out of the dispensing orifice 6. Interconnected to the perimeter of the center panel 4 is an inner sidewall 100 that extends upwardly to a raised rim 10, which may be raised above the center panel 4 (measured from the top of the raised rim to the upper surface of the center panel) a height between about 0.05 inches and about 0.30 inches. In a preferred embodiment, the top of the raised rim 10 is raised above the upper surface of the center panel 4 a height of about 0.16 inches.

The raised rim 10 extends downward (away from the center panel 4) into and forming an outer sidewall 102 that interconnects to a curl 32. The curl 32 and outer sidewall 102 look similar to the lower sidewall 110 and curl 32 shown in FIG. 28 and is shown in cross-section in FIG. 72B. Portions of the curl 32 include lug features 120 (also called snap-on features) to aid in securing the lid 2 to the cup. Specifically, the lug features 120 snap onto and engage the curl of the cup. The lid 2 can have two or more lug features 120 in some embodiments. In a preferred embodiment, the lid 2 comprises three or more lug features 120. The lid 2 shown comprises four lug features 120. More than four lugs 120 are possible in other embodiments. Additionally, the lugs 120 can be longer or shorter (arc length) than shown in the drawings.

FIG. 57 is a bottom perspective view of the metallic dispensing lid 2. FIG. 58 is a front elevation view of the metallic dispensing lid 2, the right, left, and rear elevation views being substantially the same as the front elevation view. FIG. 59 is a top plan view of the metallic dispensing lid 2. In some embodiments, the diameter D1 of the vent hole 8 is between about 0.05 inch and 0.3 inch, or 0.05 inch, 0.1 inch, 0.15 inch, 0.2 inch, 0.25 inch, and 0.3 inch, or a range or value between two of these values. In a preferred embodiment, the diameter D1 of the vent hole 8 is about 0.2 inch. In one embodiment, the length L1 in the radial direction of the dispensing orifice 6 is between about 0.5 inch and 1.5 inch, or 0.5 inch, 0.7 inch, 0.9 inch, 1.0 inch, 1.1 inch, 1.3 inch, and 1.5 inch, or a range or value between two of these values. In a preferred embodiment, the length L1 in the radial direction of the dispensing orifice 6 is about 1.0 inch. In one embodiment, the length L2 of the dispensing orifice 6 in the horizontal direction as shown in FIG. 59 is between about 0.5 inch and about 1.1 inch, or 0.5 inch, 0.6 inch, 0.7 inch, 0.8 inch, 0.9 inch, 1.0 inch, and 1.1 inch, or a range or value between two of these values. In a preferred embodiment, the length L2 of the dispensing orifice 6 in the horizontal direction as shown in FIG. 59 is about 0.8 inch. FIG. 60 is a bottom plan view of the metallic dispensing lid 2.

FIG. 61 is a cross-sectional front elevation view of the metallic dispensing lid taken at the line 61-61 in FIG. 59. This cross-section is taken through the lug features. A cross-sectional elevation view taken through a portion of the lid without the lug features is shown in FIG. 72B.

FIGS. 61, 61A, and 61B show various dimensional measurements for the lid 2. The term “about” can mean a variation of +/−10% on a relative basis. In one embodiment, the outer diameter OD of the lid 2 is between about 3.6 inches and about 4.4 inches, or 3.6 inches, 3.7 inches, 3.8 inches, 3.9 inches, 4.0 inches, 4.1 inches, 4.2 inches, 4.3 inches, and 4.4 inches, or a range or value between two of these values. In a preferred embodiment, the outer diameter OD of the lid 2 is about 4.0 inches. In one embodiment, the inner diameter ID of the lid 2 is between about 3.3 inches and 4.0 inches, or 3.3 inches, 3.4 inches, 3.5 inches, 3.6 inches, 3.7 inches, 3.8 inches, 3.9 inches, and 4.0 inches, or a range or value between two of these values. In a preferred embodiment, the inner diameter ID of the lid 2 is 3.6 inches. In one embodiment, the diameter D5 of the outer sidewall 102 is between about 3.5 inches and about 4.5 inches, or 3.5 inches, 3.7 inches, 3.9 inches, 4.0 inches, 4.1 inches, 4.3 inches, and 4.5 inches, or a range or value between two of these values. In a preferred embodiment, the diameter D5 of the outer sidewall 102 is about 3.9 inches.

In one embodiment, the height H1 of the lid 2 is between about 0.1 inch and about 0.3 inch, or 0.1 inch, 0.15 inch, 0.18 inch, 0.2 inch, 0.25 inch, and 0.3 inch, or a range or value between two of these values. In a preferred embodiment, the height H1 of the lid 2 is about 0.18 inch. In one embodiment, the height H2 of the curl 32 is between about 0.05 and 0.2 inch, or 0.05, 0.075 inch, 0.1 inch, 0.105 inch, 0.125 inch, 0.15 inch, 0.175 inch, and 0.2 inch, or a range or value between two of these values. In a preferred embodiment, the height H2 of the curl 32 is about 0.105 inch. In one embodiment, the height H9 of the lug feature 120 is between about 0.05 inch and 0.15 inch, or 0.05 inch, 0.075 inch, 0.827 inch, 0.1 inch, 0.125 inch, and 0.15 inch, or a range or value between two of these values. In a preferred embodiment, the height H9 of the lug feature 120 is about 0.0827 inch. In some embodiments, the height H5 from the center panel 4 to the raised rim 10 is between about 0.1 inch and 0.2 inch, or 0.1 inch, 0.125 inch, 0.15 inch, 0.166 inch, 0.175 inch, and 0.2 inch, or a range or value between two of these values. In a preferred embodiment, the height H5 from the center panel 4 to the raised rim 10 is about 0.166 inch.

In one embodiment, the cup curl 44 radius of curvature R1 is between about 0.04 inch and about 0.08 inch, or 0.04 inch, 0.05 inch, 0.06 inch, 0.0625 inch, 0.07 inch, and 0.08 inch, or a range or value between two of these values. In a preferred embodiment, the cup curl 44 radius of curvature R1 is about 0.0625 inch. In one embodiment, the rounded corner 124 radius of curvature R2 is between about 0.04 inch and about 0.08 inch, or 0.04 inch, 0.05 inch, 0.055 inch, 0.06 inch, 0.61 inch, 0.07 inch, and 0.08 inch, or a range or value between two of these values. In a preferred embodiment, the rounded corner 124 radius of curvature R2 is about 0.055 inch or 0.061 inch. In one embodiment, the radius of curvature R3 of the inner curved portion 130 of the lug feature 120 is between about 0.015 inch and 0.045 inch, or 0.015 inch, 0.02 inch, 0.026 inch, 0.03 inch, 0.035 inch, 0.04 inch, and 0.045 inch, or a range or value between two of these values. In a preferred embodiment, the radius of curvature R3 of the inner curved portion 130 of the lug feature 120 is about 0.026 inch. In one embodiment, the radius of curvature R4 of the upper/outer curved portion 126 of the lug feature 120 is between about 0.025 inch and 0.06 inch, or 0.025 inch, 0.03 inch, 0.035 inch, 0.04 inch, 0.0415 inch, 0.045 inch, 0.05 inch, 0.055 inch, and 0.06 inch, or a range or value between two of these values. In a preferred embodiment, the radius of curvature R4 of the upper/outer curved portion 126 of the lug feature 120 is about 0.0415 inch. In one embodiment, the lid curl 32 radius of curvature R5 is between about 0.03 inch and 0.07 inch, or 0.03 inch, 0.04 inch, 0.0415 inch, 0.05 inch, 0.06 inch, and 0.07 inch, or a range or value between two of these values. In a preferred embodiment, the lid curl 32 radius of curvature R5 is about 0.0415 inch.

In one embodiment, the angle A1 of the linear portion 128 of the lug 120 relative to the horizontal or center panel 4 is between about 20° and 35°, or 20°, 23°, 28°, 30°, 32°, and 35°, or a range or value between two of these values. In a preferred embodiment, the angle A1 of the linear portion 128 of the lug 120 relative to the horizontal or center panel 4 is about 28°. In one embodiment, the angle A2 of the upper linear portion of the lug 120 connected to the outer sidewall 102 relative to the horizontal or the center panel 4 is between about 25° and 35°, or 25°, 27°, 29°, 30°, 31°, 33°, and 35°, or a range or value between two of these values. In a preferred embodiment, the angle A2 of the upper linear portion of the lug 120 connected to the outer sidewall 102 relative to the horizontal or the center panel 4 is about 30°.

FIG. 61A is an enlarged view of the lug feature 120 shown in cross-section without a cup. The lug feature 120 comprises folded metal that protrudes inwardly as compared to the lid curl 32 and the outer sidewall 102 (see, e.g., FIG. 72B). Thus, the metal that would form the curl 32 can be cut (to separate it from the rest of the curl) or squished, bent, or deformed to form the lug, bent upward, and bent inward to create the lug feature 120. Specifically, the lug feature 120 comprises a portion extending inward and at a downward angle from the lower sidewall 102, which is interconnected to an inner curved portion 130 interconnected to a substantially linear portion 128 extending outward and upward at an angle, which is interconnected to an upper curved portion 126 that curves inward to hide the cut end 132. The lid curl 32 can also be seen in this view because it is positioned behind the lug feature 120. However, the shape, size, and position of the curl is somewhat deceiving in FIGS. 61A-B because the curl 32 shown is actually a distance behind and to the left of the lug feature 120, since the lid 2 is circular. Thus, the outer diameter of the lug feature 120 is actually smaller, albeit only slightly, than the outer diameter of the curl 32. This is more easily seen in FIGS. 56-60. The dashed lines in FIG. 61A are phantom lines showing the portion of the curl 32 and lug feature 120 behind the cut portion. FIG. 61B is the same enlarged view of the lug feature 120 as FIG. 61A but also shows a cup 40 attached to the lid 2. In use, the lug features 120 snap onto the curl 44 of the cup 40 via the spring effect. As the user pushes the lid 2 down on the cup 40, the lug feature 120 is bent outward by the cup's curl 44 and the lug feature 120 springs back inward (toward the cup 40 and toward the lid 2 center axis or centerline) and around the curl 44 of the cup 40 to hold the lid 2 on the cup 40 once the cup curl 44 is fully positioned within the lid 2. It is the inward extending portion of the lug feature 120 that engages a lower portion of the cup's curl 44 to hold the lid 2 onto the cup 40.

The outer diameter of the inner sidewall 100 of the lid 2 is approximately the same as the inner diameter of the upper portion of the cup 40. Thus, the outer surface of the inner sidewall 100 is positioned adjacent to the inner surface of the cup 40, as shown in FIG. 61B. By having the substantially same diameter, the lid 2 forms a plug seal to keep the fluid in the cup 40.

FIG. 61C is a cross-sectional view of a portion of the lid 2 interconnected to the upper end of a cup 40. FIG. 61C shows an alternative embodiment where a dimple feature 122 is used instead of the lug feature. A dimple or protuberance 122 is formed on an inner surface of the lid 2, for example the inner surface of the outer sidewall 110, such that the dimple feature 122 interacts with the curl 44 of the cup 40. Similar to the lug feature, the curl 32 and the outer sidewall 110 of the lid 2 move away from the lid centerline as the cup curl 44 is inserted into the lid 2. Once the curl 44 of the cup 40 is in position, the lid curl 32 and outer sidewall 110 snap back into their original positions. The dimple feature 122 extends under the cup curl 44 and holds the cup curl 44 within the receiving portion of the lid 2. The dimple feature 122 may extend around the entire circumference of the lid 2 or it may extend only a certain arc length, for example 5° to 25°, around the lid 2. If the dimple feature 122 only extends a certain arc length around the lid 2 and not along the entire circumference, then multiple dimple features 122 may be used, similar to the lug features. For example, the lid 2 could have two dimple features 122, three dimple features 122, four dimple features 122, or five or more dimple features 122. In some embodiments, the dimple feature 122 is embossed into the lid 2 from the outside, pressed into the lid 2, or otherwise formed in the lid 2. In some embodiments, the dimple feature 122 has a circular, spherical, semi-circular, or semi-spherical shape. In other embodiments, the dimple feature 122 has an extended ovular shape or a semi-extended-ovular shape, meaning it is shaped like a wide circle or half of a wide circle. In embodiments with one or more dimple features 122, the lid curl 32 is not interrupted or disrupted like it is with embodiments having one or more lug features.

However, the lids can be larger or smaller (e.g., in diameter) depending on the size of the cup in which the lid is used and the size and shape of the dispensing orifice can change depending on the desired final use and still be within the scope of the invention. The dimensional data provided here is provided as an example of one embodiment. Embodiments of the lid with other dimensions are within the scope of the invention and this disclosure.

FIG. 62 is a perspective view of the metallic dispensing lid 2 of FIG. 56 interconnected to a cup 40. In the embodiment shown, the cup 40 is a tapered cup with multiple tapered portions 42 formed by ribs 42. The cup 40 has a curl 44 at the top or upper end 46 of the cup 40, a closed bottom 48 opposite the upper end 46, and a body 50 having a sidewall 52 or sidewall portions therebetween. The sidewall 52 comprises a plurality of tapered portions 42 formed by ribs 42.

FIG. 63 is a front elevation view of the metallic dispensing lid 2 and cup 40, the right, left, and rear elevation views being substantially the same as the front elevation view. FIG. 64 is a top plan view of the metallic dispensing lid 2 and cup 40. FIG. 65 is a bottom plan view of the metallic dispensing lid 2 and cup 40. FIG. 66 is an exploded perspective view of the metallic dispensing lid 2 and cup 40.

FIG. 67 is a top perspective view of a seventh embodiment of a metallic dispensing lid 2. The lid 2 of FIGS. 67-77 is the same as the lid 2 of FIGS. 56-66 except that the lid 2 of FIGS. 67-77 includes different lug features 120 (also called snap-on features) than the lug features 120 of the lid 2 of FIGS. 56-66. The lug features 120 (also called snap-on features) aid in securing the lid 2 to the cup 40. Specifically, the lug features 120 snap onto and engage the curl 44 of the cup 40. Thus, any redundant description of FIGS. 56-66 will not be presented here, and the description of FIGS. 56-66 is incorporated here by this reference. The lid 2 can have two or more lug features 120 in some embodiments. In a preferred embodiment, the lid 2 comprises three or more lug features 120. The lid 2 shown comprises four lug features 120. More than four lugs 120 are possible in other embodiments. The lug features 120 include a transitional feature 134 or transitional portion 134 where the metal of the curl transitions to the lug feature 120. Additionally, the lugs 120 can be longer or shorter (arc length) than shown in the drawings.

FIG. 68 is a bottom perspective view of the metallic dispensing lid 2. FIG. 69 is a front elevation view of the metallic dispensing lid 2, the right, left, and rear elevation views being substantially the same as the front elevation view. FIG. 70 is a top plan view of the metallic dispensing lid 2. In some embodiments, the diameter D1 of the vent hole 8 is between about 0.05 inch and 0.3 inch, or 0.05 inch, 0.1 inch, 0.15 inch, 0.2 inch, 0.25 inch, and 0.3 inch, or a range or value between two of these values. In a preferred embodiment, the diameter D1 of the vent hole 8 is about 0.2 inch. In one embodiment, the length L1 in the radial direction of the dispensing orifice 6 is between about 0.5 inch and 1.5 inch, or 0.5 inch, 0.7 inch, 0.9 inch, 1.0 inch, 1.1 inch, 1.3 inch, and 1.5 inch, or a range or value between two of these values. In a preferred embodiment, the length L1 in the radial direction of the dispensing orifice 6 is about 1.0 inch. In one embodiment, the length L2 of the dispensing orifice 6 in the horizontal direction as shown in FIG. 70 is between about 0.5 inch and about 1.1 inch, or 0.5 inch, 0.6 inch, 0.7 inch, 0.8 inch, 0.9 inch, 1.0 inch, and 1.1 inch, or a range or value between two of these values. In a preferred embodiment, the length L2 of the dispensing orifice 6 in the horizontal direction as shown in FIG. 70 is about 0.8 inch. FIG. 60 is a bottom plan view of the metallic dispensing lid 2. FIG. 71 is a bottom plan view of the metallic dispensing lid.

FIG. 72 is a cross-sectional front elevation view of the metallic dispensing lid 2 taken at the line 72-72 in FIG. 70. This cross-section is taken through the lug features 120 and an enlarged view of the lug feature 120 cross section is shown in FIG. 72A. A cross-sectional elevation view taken through a portion of the lid 2 without the lug features is shown in FIG. 72B, i.e., taken at the line B-B in FIG. 70. As shown in FIG. 72B, the center panel 4 is connected to a substantially vertical inner sidewall 100, which interconnects to the raised rim 10. Then the raised rim 10 extends downward, terminating in the lid curl 32.

FIGS. 72, 72A, and 72B show various dimensional measurements for the lid 2. The term “about” can mean a variation of +/−10% on a relative basis. In one embodiment, the outer diameter OD of the lid 2 is between about 3.6 inches and about 4.4 inches, or 3.6 inches, 3.7 inches, 3.8 inches, 3.9 inches, 4.0 inches, 4.1 inches, 4.2 inches, 4.3 inches, and 4.4 inches, or a range or value between two of these values. In a preferred embodiment, the outer diameter OD of the lid 2 is about 4.0 inches. In one embodiment, the inner diameter ID of the lid 2 is between about 3.3 inches and 4.0 inches, or 3.3 inches, 3.4 inches, 3.5 inches, 3.6 inches, 3.7 inches, 3.8 inches, 3.9 inches, and 4.0 inches, or a range or value between two of these values. In a preferred embodiment, the inner diameter ID of the lid 2 is 3.6 inches. In one embodiment, the diameter D5 of the outer sidewall 102 is between about 3.5 inches and about 4.5 inches, or 3.5 inches, 3.7 inches, 3.9 inches, 4.0 inches, 4.1 inches, 4.3 inches, and 4.5 inches, or a range or value between two of these values. In a preferred embodiment, the diameter D5 of the outer sidewall 102 is about 3.9 inches.

In one embodiment, the height H1 of the lid 2 is between about 0.1 inch and about 0.3 inch, or 0.1 inch, 0.15 inch, 0.18 inch, 0.2 inch, 0.25 inch, and 0.3 inch, or a range or value between two of these values. In a preferred embodiment, the height H1 of the lid 2 is about 0.18 inch. In one embodiment, the height H2 of the curl 32 is between about 0.05 and 0.2 inch, or 0.05, 0.075 inch, 0.1 inch, 0.105 inch, 0.125 inch, 0.15 inch, 0.175 inch, and 0.2 inch, or a range or value between two of these values. In a preferred embodiment, the height H2 of the curl 32 is about 0.105 inch. In one embodiment, the height H9 of the lug feature 120 is between about 0.05 inch and 0.15 inch, or 0.05 inch, 0.075 inch, 0.827 inch, 0.1 inch, 0.125 inch, and 0.15 inch, or a range or value between two of these values. In a preferred embodiment, the height H9 of the lug feature 120 is about 0.0827 inch. In some embodiments, the height H5 from the center panel 4 to the raised rim 10 is between about 0.1 inch and 0.2 inch, or 0.1 inch, 0.125 inch, 0.15 inch, 0.166 inch, 0.175 inch, and 0.2 inch, or a range or value between two of these values. In a preferred embodiment, the height H5 from the center panel 4 to the raised rim 10 is about 0.166 inch.

In one embodiment, the cup curl 44 radius of curvature R1 is between about 0.04 inch and about 0.08 inch, or 0.04 inch, 0.05 inch, 0.06 inch, 0.0625 inch, 0.07 inch, and 0.08 inch, or a range or value between two of these values. In a preferred embodiment, the cup curl 44 radius of curvature R1 is about 0.0625 inch. In one embodiment, the rounded corner 124 radius of curvature R2 is between about 0.04 inch and about 0.08 inch, or 0.04 inch, 0.05 inch, 0.055 inch, 0.06 inch, 0.61 inch, 0.07 inch, and 0.08 inch, or a range or value between two of these values. In a preferred embodiment, the rounded corner 124 radius of curvature R2 is about 0.055 inch or 0.061 inch. In one embodiment, the radius of curvature R3 of the inner curved portion 130 of the lug feature 120 is between about 0.015 inch and 0.045 inch, or 0.015 inch, 0.02 inch, 0.026 inch, 0.03 inch, 0.035 inch, 0.04 inch, and 0.045 inch, or a range or value between two of these values. In a preferred embodiment, the radius of curvature R3 of the inner curved portion 130 of the lug feature 120 is about 0.026 inch. In one embodiment, the radius of curvature R4 of the upper/outer curved portion 126 of the lug feature 120 is between about 0.025 inch and 0.06 inch, or 0.025 inch, 0.03 inch, 0.035 inch, 0.04 inch, 0.0415 inch, 0.045 inch, 0.05 inch, 0.055 inch, and 0.06 inch, or a range or value between two of these values. In a preferred embodiment, the radius of curvature R4 of the upper/outer curved portion 126 of the lug feature 120 is about 0.0415 inch. In one embodiment, the lid curl 32 radius of curvature R5 is between about 0.03 inch and 0.07 inch, or 0.03 inch, 0.04 inch, 0.0415 inch, 0.05 inch, 0.06 inch, and 0.07 inch, or a range or value between two of these values. In a preferred embodiment, the lid curl 32 radius of curvature R5 is about 0.0415 inch.

In one embodiment, the angle A1 of the linear portion 128 of the lug 120 relative to the horizontal or center panel 4 is between about 20° and 35°, or 20°, 23°, 28°, 30°, 32°, and 35°, or a range or value between two of these values. In a preferred embodiment, the angle A1 of the linear portion 128 of the lug 120 relative to the horizontal or center panel 4 is about 28°. In one embodiment, the angle A2 of the upper linear portion of the lug 120 connected to the outer sidewall 102 relative to the horizontal or the center panel 4 is between about 25° and 35°, or 25°, 27°, 29°, 30°, 31°, 33°, and 35°, or a range or value between two of these values. In a preferred embodiment, the angle A2 of the upper linear portion of the lug 120 connected to the outer sidewall 102 relative to the horizontal or the center panel 4 is about 30°.

FIG. 72A is an enlarged view of the lug feature 120 shown in cross-section with a cup 40. The lug feature 120 comprises folded metal that protrudes inwardly as compared to the lid curl 32 and the lower sidewall 110 (FIG. 72B). Thus, the metal that would form the curl 32 is bent or squished forming a transitional portion 134, bent upward, and bent inward to create the lug feature 120. Specifically, the lug feature 120 comprises a portion extending inward and at a downward angle from the lower sidewall 110, which is interconnected to an inner curved portion 130 interconnected to a substantially flat or linear portion 128 extending outward and upward at an angle, which is interconnected to an upper curved portion 126 that curves inward to hide the cut end 132. In use, the lug features 120 snap onto the curl 44 of the cup 40 via the spring effect or another biasing effect. As the user pushes the lid 2 down on the cup 40, the lug feature 120 is bent outward by the cup's curl 44 and the lug feature 120 springs back inward (toward the cup 40 and toward the lid 2 center axis or centerline) and around the curl 44 of the cup 40 to hold the lid 2 on the cup 40 once the cup curl 44 is fully positioned within the lid 2. It is the inward extending portion of the lug feature 120 that engages a lower portion of the cup's curl 44 to hold the lid 2 onto the cup 40.

FIG. 72C is an enlarged top plan view of the pour opening 6 and lug feature 120 of the lid of FIG. 69. The lug feature 120 has a transitional portion 134 on either side of the lug 120. In some embodiments, the length L3 of the lug 120 span is between about 6° and 10°, or 6°, 7°, 8°, 9°, and 10°, or a range or value between two of these values. In a preferred embodiment, the length L3 of the lug 120 span is about 8°. In some embodiments, the length L4 of the transitional portion 134 span is between about 0.5° and 3.5°, or 0.5°, 1°, 1.5°, 2.5°, 3°, and 3.5°, or a range or value between two of these values. In a preferred embodiment, the length L4 of the transitional portion 134 span is about 2°.

However, the lids can be larger or smaller (e.g., in diameter) depending on the size of the cup in which the lid is used and the size and shape of the dispensing orifice can change depending on the desired final use and still be within the scope of the invention. The dimensional data provided here is provided as an example of one embodiment. Embodiments of the lid with other dimensions are within the scope of the invention and this disclosure.

FIG. 73 is a perspective view of the metallic dispensing lid 2 interconnected to a cup 40. In the embodiment shown, the cup 40 is a tapered cup with multiple tapered portions 42 formed by ribs 42. The cup 40 has a curl 44 at the top or upper end 46 of the cup 40, a closed bottom 48 opposite the upper end 46, and a body 50 having a sidewall 52 or sidewall portions therebetween. The sidewall 52 comprises a plurality of tapered portions 42 formed by ribs 42.

FIG. 74 is a front elevation view of the metallic dispensing lid 2 and cup 40, the right, left, and rear elevation views being substantially the same as the front elevation view. FIG. 75 is a top plan view of the metallic dispensing lid 2 and cup 40. FIG. 76 is a bottom plan view of the metallic dispensing lid 2 and cup 40. FIG. 77 is an exploded front view of the metallic dispensing lid 2 and cup 40.

FIG. 78 is a flow chart of one embodiment of the production flow to produce the lid, i.e., the method of manufacturing the lid. The lid stars from a coil, which may be precoated or chemically treated. The coil is fed into a transfer press where the cup or lid shape is formed, the curl is formed, the lug features (if included in the embodiment being made) are formed, and the dispensing orifice and/or the vent hole is/are pierced. In some embodiments, no holes are pierced in the lid. Then the lids exit and are stacked, bagged, and palletized.

FIG. 79 is a flow chart of another embodiment of the production flow to produce the lid, i.e., the method of manufacturing the lid. The lid starts from a coil, which may be precoated or chemically treated. The coil is fed into a stamping press that first punches a series of holes into the metal and cuts the metal into a circle called a blank. The series of holes will become the dispensing orifice and the vent hole in the final product. Alternatively, the holes can be punched into the lid at the end of the manufacturing process, i.e., after the curl is formed. The stamping press then produces an intermediate aluminum form called a cup. The cup is fed into a reform cupper, which performs the secondary draw where the cup is drawn into a near-finished version of the final lid product with a small flange around the circumference. Curlers form the curl by curling the flange over to hide the cut edge. Then the lids exit and are stacked, bagged, and palletized.

FIG. 80 is a flow chart of another embodiment of the production flow to produce the lid. The lid starts from a coil, which may be precoated or chemically treated. The coil is pierced, meaning one or more holes are stamped into the metal. The one or more holes will become the dispensing orifice and/or the vent hole in the final product. Alternatively, the holes can be punched into the lid at the end of the manufacturing process, i.e., after the curl is formed. Then the coil is cut into a circle called a blank. The blank then goes to a cupper and curler where the lid shape is formed with a small flange around the circumference. Curlers form the curl by curling the flange over to hide the cut edge. Then the lug features are formed in the curl if the embodiment includes lug features. Finally, the lids exit and are stacked, bagged, and palletized.

FIG. 81 is a flow chart of another embodiment of the production flow to produce the lid. The lid starts from a coil, which may be precoated or chemically treated. The coil is pierced, meaning one or more holes are stamped into the metal. The one or more holes will become the dispensing orifice and/or the vent hole in the final product. Alternatively, the holes can be punched into the lid at the end of the manufacturing process, i.e., after the curl is formed. Then the coil is cut into a circle called a blank. The blank then goes to a cupper where the lid shape is formed with a small flange around the circumference. Next the lid goes to a curler that forms the curl by curling the flange over to hide the cut edge. Then the lug features are formed in the curl if the embodiment includes lug features. Finally, the lids exit and are stacked, bagged, and palletized.

FIG. 82 is a flow chart of another embodiment of the production flow to produce the lid. The lid starts from a coil, which may be precoated or chemically treated. Then the coil is cut into a circle called a blank. The blank then goes to a cupper where the lid shape is formed with a small flange around the circumference. Next the lid goes to a curler that forms the curl by curling the flange over to hide the cut edge. Then the lug features are formed in the curl if the embodiment includes lug features. Next, the coil is pierced, meaning one or more holes are stamped into the metal. The one or more holes will become the dispensing orifice and/or the vent hole in the final product. Finally, the lids exit and are stacked, bagged, and palletized.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

It is to be appreciated that any feature described herein can be claimed in combination with any other feature(s) as described herein, regardless of whether the features come from the same described embodiment.

What is claimed is:

1. A metallic dispensing lid, comprising:
a center panel having a dispensing orifice;
a sidewall interconnected to a perimeter of the center panel, the sidewall extending upwardly from the center panel;
a raised rim interconnected to the sidewall; and
a curl interconnected to an outer portion of the raised rim and positioned below the raised rim.

2. The metallic dispensing lid of claim 1, further comprising at least two lug features in the curl, wherein the at least two lug features are biased inwardly and configured to removably interconnect the lid to a peripheral curl of a cup.

3. The metallic dispensing lid of claim 1, wherein the dispensing orifice has a triangular shape with a wide end and narrow end, and wherein the wide end is positioned proximate to the perimeter of the center panel.

4. The metallic dispensing lid of claim 1, wherein the dispensing orifice is initially closed by a tear panel defined by a score line, wherein the score line extends at least partially through a thickness of the lid, and wherein at least a portion of the tear panel stays attached to the center panel after opening.

5. The metallic dispensing lid of claim 2, wherein the at least two lug features are positioned at opposite ends of the metallic dispensing lid and can be moved between a first position where the at least two lug features are retained to the cup and a second position where the at least two lug features are released from the cup to allow removal of the lid.

6. The metallic dispensing lid of claim 5, wherein the at least two lug features each comprise an inner curved portion that is oriented toward the cup and shrouds the end of the curl from contact with a user removing the metallic dispensing lid.

7. The metallic dispensing lid of claim 2, wherein the at least two lug features extend a predetermined distance around the curl, and wherein the at least two lug features are cut into the curl.

8. The metallic dispensing lid of claim 1, wherein the raised rim has a height no greater than about 0.6 inches above the center panel.

9. The metallic dispensing lid of claim 1, wherein the metallic dispensing lid is comprised of an aluminum alloy and the aluminum alloy is blended from at least 20% of a recycled aluminum alloy.

10. The metallic dispensing lid of claim 9, wherein the recycled aluminum alloy consists of a plurality of metals including aluminum and two or more of the following: silicon, iron, copper, manganese, magnesium, zinc, titanium, or chromium.

11. The metallic dispensing lid of claim 1, further comprising a vent hole in the center panel.

12. A metallic dispensing lid, comprising:
a center panel;
a sidewall interconnected to a perimeter of the center panel, the sidewall extending upwardly from the center panel between about 0.1 inch and 0.2 inch;
a raised rim interconnected to the sidewall having a radius of curvature of between about 0.04 inch and about 0.08 inch;
a curl interconnected to an outer portion of the raised rim and positioned below the raised rim and having a radius of curvature between about 0.025 inch and 0.06 inch; and
at least two lug features formed in the curl which are biased inwardly and are configured to selectively secure and release the lid to a cup.

13. The metallic dispensing lid of claim 12, wherein the at least two lug features had an inwardly oriented curl to shroud the end of the curl to prevent contact with a user's fingers.

14. The metallic dispensing lid of claim 13, wherein the inwardly oriented curl has a radius of curvature between about 0.015 inch and 0.045 inch.

15. The metallic dispensing lid of claim 14, further comprising a liner portion extending outwardly from the inwardly oriented curl which has a length of at least 0.1 inches to provide an engagement surface for a user's fingers.

16. The metallic dispensing lid of claim 13, wherein the inwardly oriented curl extends inwardly at least about one third of a horizontal distance of the raised rim.

17. A method of manufacturing a metallic dispensing lid, the method comprising:
providing a coil of aluminum material;
forming a blank of aluminum material which has a generally circular shape;
feeding the blank into a cupper to form a lid shape with a center panel, an inner sidewall extending upwardly from the center panel, a raised rim interconnected to the inner sidewall that has a radius of curvature of between about 0.025 inch and 0.06 inch and forming a curl around a perimeter of the lid which extends downwardly from the raised rim;
forming one or more lug features in the curl; and
piercing the center panel to form one or more dispensing holes.

18. The method of manufacturing the metallic dispensing lid of claim 17, further comprising:
stacking a plurality of lids;
bagging the plurality of lids; and
palletizing the bags of lids for transportation.

19. The method of manufacturing the metallic dispensing lid of claim 17, wherein the lids are coated on at least one of an exterior and interior surface after forming one or more lug features.

20. The method of manufacturing the metallic dispensing lid of claim 17, further comprising forming an inwardly oriented curl in the lug features to shroud the end of the lug from exposure.
